(19) United States
(12) Patent Application Publication
(10) Pub. No.: US 2023/0306153 A1
(43) Pub. Date: Sep. 28, 2023

(54) METHOD AND SYSTEM FOR THE PRODUCTION OF A BUILDING

(71) Applicant: SPB SYSTEMATISCHES PLANEN & BAUEN GMBH, Schönefeld (DE)

(72) Inventors: Nils KLATTE, Ganderkesee (DE); Robert SPRAJCAR, Oranienburg (DE)

(21) Appl. No.: 18/011,809

(22) PCT Filed: Jun. 23, 2021
(86) PCT No.: PCT/EP2021/067147

§ 371 Date: Dec. 20, 2022

(30) Foreign Application Priority Data
Jun. 23, 2020 (EP) 20181659.2

(51) Int. Cl. G06F 30/20; G06F 30/13

(52) U.S. Cl. CPC G06F 30/20; G06F 30/13; G06F 2111/02

(57) ABSTRACT

The invention relates to a method and a system for producing a building, which comprises at least one building subunit. In this case, technical boundary conditions for the production of a building are first generated in that a development area and country-specific building specifications are recorded and/or analysed. On the basis of the technical boundary conditions, a building plan is created via a client-server model, a server device generating a building specification optimized for the technical boundary conditions via an algorithm of the harmonic search. Building measures for the building to be built are finally initiated on the basis of the building plan.

The invention relates to a method for producing a building comprising at least one building subunit. In a first method step, a building surface is detected and/or analysed, material-related and/or geometry-related building parameters and/or environmental-related parameters and/or parameters relating to a building subunit mix being obtained. Subsequently, text data with country-specific construction specifications are recorded, analysed and/or prepared, as a result of which a minimum square meter size and maximum square meter size of the at least one building subunit are generated. In a further step, a building plan is generated, the detected, analysed and/or prepared parameters or variables being loaded into the memory of a client. Furthermore, an input data set is generated which comprises an information content about the material-related and/or geometry-related building parameters and/or environmental-related parameters and/or parameters relating to the building subunit mix as well as the minimum square meter size and/or maximum square meter size of the at least one building subunit. The input data record is transmitted to a server device, the server device executing an algorithm of the harmonic search with reference to the input data record and generating an output data record. The output data record includes a building specification adapted to the development area and country-specific building specifications. The output data record is then transmitted to the client and a building plan with at least one building subunit is created on the basis of the output data record. In a final method step, construction measures of the building with the at least one building subunit are initiated taking into account the building plan.

The invention also relates to a system for producing a building, comprising at least one building subunit and a computer program product for producing a building plan, which is preferably used for producing a building.

### BACKGROUND AND STATE OF THE ART

The production of residential buildings, in particular apartment buildings, is extensive and complex. Technical aspects, living comfort, aesthetics and costs as well as possible uses must be taken into account and, if necessary, weighed against each other. Especially in times of housing scarcity, on the one hand, new living facility is to be quickly created, which on the other hand satisfies the above-mentioned and other requirements. This poses particular challenges for the manufacture of residential buildings. In the case of apartment buildings, individual apartments and the desired mix of different apartments (e.g. 2-room apartment, 3-room apartment), developments (e.g. staircases, entrance areas) and the requirements and restrictions with regard to the entire residential building must also be brought into relation.

Although technical standards, laws and norms of construction do exist, each building is nevertheless highly individual due to external specifications, the wishes of the client, etc., which means that, among other things, technical parameters that have an influence on the structural characteristics of the building must be determined anew each time. The production of a building (from the selection of a suitable development area to the implementation of construction measures) is currently associated with a high expenditure of time and technology and, in particular, a large number of manual steps. In particular, the complexity of various method steps for the production of a building (such as, for example, the generation of a building plan) or of the system components involved in the method steps has hitherto not made possible complete automation of these steps and, in addition, leads to a high susceptibility to errors, as a result of which the costs for the production of a building are enormously high. Furthermore, hitherto many method steps for the production of a building in the prior art have been strictly separated from one another without any possible direct bidirectional communication (during the implementation of the steps), individual method steps often being carried out in succession by different entities (persons/locations/ system components). In most cases, the steps are processed and completed individually and disadvantageously. For example, it has hitherto been customary for an architect to create a building plan and only to hand over the completed building plan to a construction manager who could not have had any significant influence on the creation of the building plan. In this case, it is quite possible that the feasibility of the building plan is associated with difficulties, since, for example, the accessibility of the building surface by the immediate surroundings is ensured only to a limited extent for large and heavy components.

There is therefore a great need for a method and a system for the “smart” production of a building, comprising at least one building subunit and a need for a computer program product for the production of a building plan, the method, the system and the computer program product satisfying the above mentioned requirements and, in particular, making possible a rapid and nevertheless customisable production of a building, taking complex technical variables into account. In this case, the need is above all to take into account as many influencing variables as possible which are relevant for the production of a building from the outset and to plan the production of the building in a forward-looking manner, so that a subsequent change or repetition of various process steps is minimized or even not necessary at all.

In addition, there is a need to give a client (or other responsible persons or bodies), among other things, a good view of the finished building in advance and to give an overview of the required materials, etc. In this way, the client can also make a qualified selection in advance from several possible residential buildings, which optimally reflects his preferences.

### OBJECTIVE OF THE INVENTION

The object of the invention was therefore to eliminate the disadvantages from the prior art and to provide a time-efficient, cost-effective, robust and error-resistant as well as automated system and method for producing a building comprising at least one building subunit, wherein the method and the system take into account a multiplicity of different, in particular technical, influencing variables with regard to building production from the outset. In addition, it is an object of the invention to provide an efficient computer program product for generating a building plan which is preferably used for the production of a building.

### SUMMARY OF THE INVENTION

The object is achieved by the features of the independent claims. Advantageous embodiments of the present invention are described in the dependent claims.

In a preferred embodiment, the invention relates to a method for producing a building comprising at least one building subunit, characterized in that the method comprises the following steps:
a. Detection and/or analysis of a building surface, wherein material-related and/or geometry-related building parameters and/or environmental-related parameters and/or parameters relating to a building subunit mix are obtained;
b. Collection, analysis and/or preparation of text data with country-specific construction specifications, which generates a minimum square meter size and maximum square meter size of the at least one building subunit;
c. Generation of a building plan, whereby
   i. the material-related and/or geometry-related building parameters and/or environmental-related parameters and/or parameters relating to the building subunit mix as well as the minimum square meter size and/or maximum square meter size of the at least one building subunit are loaded into a memory of a client;
   ii. an input data set is generated, which includes an information content on material-related and/or geometry-related building parameters and/or environmental-related parameters and/or parameters relating to the building subunit mix as well as the minimum square meter size and/or maximum square meter size of the at least one building subunit;
   iii. the client transmits the input data set to a server device;
   iv. the server device executes a harmonic search algorithm, including the input data set, and generates an output data set, the output data set comprising a building specification adapted to the development area and country-specific building specifications;
   v. the output data set is transmitted to the client and a building plan with at least one building sub-unit is created on the basis of the output data set;
d. Initiation of construction measures of the building with the at least one building subunit, taking into account the building plan.

The combination of the proposed method steps leads to a surprising synergy effect, which leads to the advantageous properties and the associated overall success of the invention, the individual features interacting with one another. An important advantage of the method according to the invention is the necessity of extremely few method steps and system components, whereby nevertheless an extremely robust and error-resistant infrastructure is generated for the production of a building. The proposed method leads to an enormous reduction in the time required for the production of a building, since on the one hand comprehensive aspects (e.g. relating to the environment, to legal framework conditions, to technical feasibility and also to individual design) are simultaneously included from the outset for the production of a building, so that changes and improvements required during production or subsequently are minimized. On the other hand, the method also makes possible, in particular, an accelerated and automated generation of a building plan which takes into account a particularly large quantity of said influencing variables. The fact that all influencing variables relevant to a construction project are recorded, analysed and subsequently processed advantageously results in an optimized building (in terms of production and use).

In a preferred embodiment, a building surface is detected and/or analysed, material-related and/or geometry-related building parameters and/or environmental-related parameters and/or parameters relating to a building subunit mix being obtained. The detection and/or analysis of the building surface advantageously leads to the fact that realistic and updated features of the building surface are obtained, as a result of which the building to be produced can be optimally adapted to these features or circumstances and, in particular, boundary conditions for the production of a building and/or the planning of the production are obtained.

For the purposes of the invention, a development area is preferably to be regarded as an area which is designed to be developed with a structure, such as, for example, a building. This is preferably a plot of land that a client has purchased.

The development area is preferably detected and/or analysed with a detection device, the detection device particularly preferably comprising a data processing unit and/or being in data connection with such a unit, which analyses the detected features. The analysis can be carried out in various ways. Thus, for example, photos taken by using a detection device can be analysed via computer vision algorithms. The evaluation of the photos refers, for example, to existing open rooms (on the building surface), which are particularly well suited for the production of a building (without the building surface having to be worked intensively), so that geometry-related parameters of the building to be produced can thereby be derived and preserved or determined. Furthermore, optical wave guides introduced into a floor (preferably fibre-optic cables) can also be set up to record floor properties which can then be analysed by the data processing unit included in the detection device. The detection and analysis is not limited to these two examples, it being clear to a person skilled in the art how such analyses can be carried out with corresponding methods and detection devices from the prior art in order subsequently to obtain material-related and/or geometry-related building parameters and/or environmental-related parameters and/or parameters relating to a building subunit mix.

Preferably, material-related building parameters are to be regarded as features of a building with respect to a material to be installed. Thus, such parameters can preferably comprise quality-related and/or quantity-related information about a material such as, for example, the type of material (namely preferably wood, glass, steel, concrete, reinforced concrete or composite material, etc.) or the quantity of material (number of pieces, weight, etc.). Material-related parameters can, for example, be dependent on the soil properties, lightweight wooden structures being preferred, for example, in regions with a compliant soil. The parameters obtained can be regarded as a pre-selection and can determine the boundary conditions for all possible materials to be used (type and/or quantity), wherein an optimization of the building specification following later in the method according to the invention is to make an exact selection from the suitable pre-selection or the boundary conditions and optimized for the building area.

Geometry-related building parameters, on the other hand, are to be understood as features which comprise properties in conjunction with the geometry of a building to be produced. For example, they can comprise the maximum height, maximum width, maximum depth, external shape of a floor plan or the greatest possible extent of a building to be produced. These parameters are preferably dependent on the size of the building surface or also on the soil properties and material properties.

Parameters which relate to the environment, that is to say parameters relating to the environment, can preferably be regarded as features of the immediate environment or else as features of the extended environment of the built-up area. Thus, for example, a busy road can be located in the immediate vicinity of the building surface, as a result of which the building to be produced requires particularly noise-resistant walls. On the other hand, in an extended environment, i.e. in a region, there may be an increased snowfall probability, since the building surface is located, for example, at an altitude of 1500 m above sea level. Thus, in such a case, a flat roof should preferably be dispensed with, since this would fail under a possible load of snow. An environment-related parameter can accordingly be defined, for example, by a GPS signal which is received via a GPS device (detection device) and which indicates the exact location of the built-up area.

Parameters relating to the building subunit mix are furthermore preferably to be regarded as features with regard to the apartment sizes and/or number of rooms. Depending on the construction project, different types of apartments may be desired, for example a classic 2-room apartment for barrier-free elderly living via maisonette types, shared apartment type with living room-kitchen up to the 3-storey terraced house type or the spacious roof terrace apartment. It goes without saying that the mix of apartments also depends on the building area. For example, a generous roof terrace apartment in a north-facing and shaded side of a building may not be necessary, as this would not be subject to frequent use by a resident due to the shadow. The parameters relating to a building subunit mix also preferably define the boundary conditions for an optimized building specification. Thus, for example, the parameters can define which of the above mentioned apartment types are to be excluded for the optimization of the building specification carried out later in the method according to the invention or for the building to be produced. The parameters relating to the building subunit mix can furthermore be designed as a ratio of different types of apartments (building subunits) which are to be included in a building to be produced. Depending on the building area, such a ratio can include, for example, 75% 2-room apartments to 25% 3-room apartments (without being limited to this). All ratios of apartment types are conceivable.

The analysis of the building surface is preferably carried out via a data processing unit which can either be included in the detection device or else is in data connection with the latter, it being possible in this case for it to be placed at a separate location. Various algorithms encompassed on the data processing unit can evaluate the recorded data (for example “machine learning algorithms”) and finally determine or generate the above-mentioned parameters (material-related and/or geometry-related building parameters and/or environmental-related parameters and/or parameters relating to a building subunit mix). However, variants are also possible in which the recorded data are analysed by a person and the latter filters out and calculates the above-mentioned parameters from the bandwidth of information and preferably makes them available to a client.

In a preferred embodiment, text data with country-specific construction specifications are acquired, analysed and/or processed, as a result of which a minimum square meter size and maximum square meter size of the at least one building subunit are generated. A person skilled in the art can see how such analyses can be carried out with corresponding methods and detection devices from the prior art in order subsequently to derive a minimum square meter size and maximum square meter size of the (at least) one building subunit. Preferably, the building subunit is to be understood as an apartment. The text data are preferably in paper form and/or in digital form. In the case of text data present in paper form, these are first converted into digital text data via suitable recording devices. Furthermore, digital text data must be available in such a way that they can be processed and analysed by computer-implemented algorithms. For this purpose, texts contained in image data may be converted into computer-readable and -editable text data. The detection device preferably comprises a data processing unit and/or is in data connection with such a unit, which can carry out suitable methods, namely, for example, OCR conversion, for such a conversion. OCR refers to automated text recognition or automatic font recognition within images. Originally, automatic text recognition was based on optical character recognition (OCR). This technique is preferably replaced within the meaning of the invention by neural networks which process entire lines instead of individual characters.

Technical, environmental and/or social requirements are preferably defined in country-specific regulations and/or laws. The preferred square meter sizes (minimum square meter size and maximum square meter size of the at least one building subunit) are preferably derived directly from the country-specific regulation for subsidized housing. For example, by maintaining a corresponding size for a building and/or a building subunit, a client receives a subsidy from the respective country or the municipality for the realization. However, the federal organization in Germany or Europe does not require a homogeneous regulation for the promotion of housing. For example, there are subsidy models which already provide for subsidy during the construction period and other models which provide for subsidy only during the rental period. Preferably, the regulations and laws, which are present in text form, are first detected, analysed and/or processed by suitable measures, in particular via a detection device with a data processing unit, so that all relevant data can be filtered out of these text data. The simplest method for filtering out the relevant data (minimum square meter size and maximum square meter size of the at least one building subunit) can preferably be seen in searching the texts for keywords. Furthermore, neural networks can also be used in order to carry out semantic analyses of the texts and to obtain the relevant variables (minimum square meter size and maximum square meter size of the at least one building subunit).

In a further preferred embodiment, it is possible for a client to manually introduce some or all of the above mentioned parameters via suitable interfaces of the detection device and/or the client, in order, in particular, also to incorporate individual wishes of the client into the production of the building. Furthermore, all the above-mentioned parameters can preferably also be regarded as boundary conditions for the production of a building, on the basis of which the planning and subsequently the actual production preferably takes place.

In a further preferred embodiment, all said parameters are continuously updated or maintained in that, in particular, the detection device (or data processing unit) detects and analyses the building surface continuously or at short time intervals-preferably also during the production process of the building. This advantageously leads to the fact that it is possible to react to changed parameters in a direct manner by means of a suitable reaction, even during the preparation.

Furthermore, a building plan for the production of a building is preferably produced in one method step, this preferably being a computer-implemented method and/or, inter alia, a computer program product which is stored in a medium which can be used for computer purposes. One innovation of the proposed computer-implemented method lies, inter alia, in the fact that the building plan is produced in as decentralized a manner as possible by different components participating in the method. Thus, different planning aspects are divided between different entities (client-server model). In addition, the proposed method makes possible a particularly efficient generation of a building plan, in which extremely low calculation resources are required and nevertheless all the specified boundary conditions (parameters) are included.

For the purposes of the invention, a client is preferably set up for loading all the parameters described above into a memory, it being possible for the client to be in data connection with the detection device and for the data to be transmitted directly from the latter or else to have an interface which allows a person to enter the above mentioned parameters manually. The persons can be, for example, a builder or persons involved in a construction, such as an architect, construction manager, craftsman, etc. So that the expertise of such persons can also be manually included in the planning of a building.

Preferably, an information content about the above-described parameters included in an input data set is to be understood as meaning information and/or a content of a message about the parameters, the information and/or the content of a message preferably being composed of characters and codes-in the form of a file. The information content is preferably independent of the form of existence (characters and codes), but within the meaning of the invention is preferably to be regarded only as a meaning in terms of content, which can be represented, secured and transmitted in various forms. The client and the server device preferably comprise means for extracting and/or reading an information content from a data record or a file. The information content of the parameters can include the parameters as such-for example as a numerical value-or else more extensive information which derives from the parameters.

Furthermore, the client is set up to generate an input data record, the data record being stored in a file format selected from the group comprising PDF, JSON, XML, CSV. PDF files are very universally usable on different data processing systems, while one of the great advantages of JSON files is the simplicity of implementation and application. Due to the simple structure, JSON files do not require many resources in the application. In this way, extensive data can be evaluated in an acceptable time. The XML format can advantageously be connected to other systems without great effort, so that there is particularly good compatibility. XML is equally suitable for long-term file storage and XML can also be easily converted into other file formats. The CSV file format is advantageously versatile. The great advantage of the CSV format is still its easy portability, such as the import into different databases or programs. In existing databases, content from CSV files can be read in many ways. It is particularly advantageous if different data sources (for example data from different detection devices) are to be combined to form a single data set.

The file formats to be used are not insignificant for the proposed method and system, since they have an influence on the calculation speed, the memory and the transmission speed. The interaction of the file formats with the client, the server device and/or, in particular, the algorithm of the harmonic search, contribute, inter alia, to the technical character of the invention. It has also been found that, in particular, the input data set with an information content about the material-related and/or geometry-related building parameters and/or environmental-related parameters and/or parameters relating to the building subunit mix, as well as the minimum square meter size and/or maximum square meter size of the at least one building subunit, can be stored particularly well in the aforementioned file formats without having to accept relevant information losses.

According to the invention, a client is a data processing unit which preferably has access (or means for such access) to the Internet. The client is preferably positioned as a terminal and remote from a server device. In a preferred variant, the client is in data connection with the data processing unit assigned to the detection device and/or the detection device and can further process the data received from the data processing unit.

The infrastructure required for the method according to the invention preferably comprises a client and a server device and is preferably to be regarded as a so-called client-server model. This involves, in particular, a distribution of tasks within a network. The decentralized configuration of the entities involved in the generation of a building plan (client-server model) permits, in particular, a simultaneous generation of a plurality of building plans from a different location in a short time. Thus, for example, a first detection device can detect, analyse and prepare a first development area in a county and, in addition, the regulations applicable in this county, the regulations being present in text data. Simultaneously, a further detection device can detect a development area in a further city but in the same county. The respective detection devices are in each case assigned to a client and are in data connection with the latter, the client subsequently generating in each case an input data record and transmitting the latter to the server device. The server device can (simultaneously) generate an output data record on the basis of the two input data records, the output data record comprising a building specification optimally adapted to the respective building surface and country-specific building specifications. Advantageously, the server device can use the acquired data cooperatively, so that the second acquisition device does not have to acquire, analyse and/or prepare text data with country-specific regulations, since the same country-specific regulations apply at the location of the further development area as at the first development area. This makes it possible to save resources and calculation times.

Since the server device is at the centre of the arrangement, all the resources of the users, such as, for example, a database, are advantageously managed centrally by the latter. Not only is the administration controlled centrally, but also the maintenance. If, for example, a software update has to be carried out, this preferably takes place only on the server device, so that the clients are not affected by this. Thanks to a central data storage and the always existing availability, it is advantageously not necessary to invest high costs in the local data storage on the individual client memories. Since clients must authenticate themselves when accessing the server, there is also advantageously easy access control and, at the same time, high security. Adding and removing clients from a system is associated with no network degradation and no major changes. In addition, the number of clients can in principle be expanded without restriction. The central data storage enables flexible applications and location-independent use.

In a further preferred embodiment, an algorithm of the harmonic search, preferably on the server device, is carried out with reference to the input data record. Harmonic Search (HS) is generally an evolutionary algorithm strategy. The harmonic search algorithm enables problem instances to be solved in an extremely short computing time and particularly low memory requirement by adapting natural (but also artificial) processes (natural selection, inheritance of properties, mutation). The algorithm of the harmonic search contributes to the technical character of the invention, since in the context of the invention the algorithm serves a technical purpose. The algorithm is to be regarded as an essential subprocess step for the production of a building, which in particular leads to the production taking place in a time-efficient and resource-saving manner, as is illustrated in the following explanations.

The harmonic search preferably tries the variables of a solution in multiple iterations
1. Leave unchanged
2. or slightly changeable
3. or completely replaced,
to preferably generate new solutions. The quality of a prepared solution is then preferably evaluated by means of heuristics. After termination of the algorithm, preferably only solutions found to be good remain in the memory of the server device.

The harmonic search is particularly robust against the introduction of further variables or parameters. In addition, more than just the best two solutions (as in the case of a genetic algorithm strategy) can advantageously be combined with one another. As a meta-heuristic algorithm, the harmonic search is strongly dependent on the selected heuristics. Therefore, the harmonious search is also not a strategy with which problems of any kind can be solved and cannot be used without suitable inventive considerations for the generation of a building plan and/or production of a building, since heuristics is strongly related to the application domain. The simple design of the algorithm is also advantageous for implementation since, in particular, the parallelization of calculations is advantageously feasible and maintainability and expandability of the algorithm are ensured. The harmonious search can also be integrated into an application without a framework, which saves possible license costs and the training time in a framework.

Generally speaking, heuristics is to be regarded as an analytical procedure in which, with limited knowledge of a system, statements are made about the system with the aid of presumptive conclusions. The conclusions thus drawn often deviate from the optimal solution. The quality of the heuristics can be determined by comparison with an optimal solution. Known heuristics are, for example, trial and error, statistical evaluation of random samples and the exclusion procedure.

For the purposes of the invention, heuristics is a mathematical function which processes the geometry-related and/or environmental-related and/or material-related and/or a building subunit mix-related parameters and outputs an estimated value about the quality of the configuration of the parameters, in the sense of the current solution.

A solution can preferably also be understood as a building solution, the building solution preferably being regarded as a specification of a building. Furthermore, a solution can be regarded as a specific aspect (building subunit mix, building geometry and/or building environment) of a building specification or as a proposal for a building specification, this being-as described-assessed by heuristics. The specification preferably has essential parameters of a building (geometry-related and/or environmental-related and/or material-related and/or a building subunit mix-related parameters, size of the building subunit) which are essential in order to be able to produce a building plan and, as a result, a building comprising a building subunit.

In a further preferred embodiment, an output data record is generated on the basis of the harmonic search, the output data record comprising a building specification adapted to the development area and country-specific building specifications. This adapted building specification can be regarded as an optimization which explores a compromise of all parameters and entities involved and thus enables a building to be produced which is optimized per se. The building area and country-specific building specifications adapted to the building specifications are preferably defined as the solution best rated by heuristics.

In a further preferred embodiment, the method is characterized in that the algorithm of the harmonic search represents an optimization and comprises the following steps:
a. Initialisation of material-related and/or geometry-related building parameters and/or environmental-related parameters and/or parameters relating to the building subunit mix as well as the minimum square meter size and/or maximum square meter size of the at least one building subunit;
b. the construction of a harmonic memory;
c. improvising new solutions;
d. Evaluate and annotate the solution and update the harmonic memory;
e. Repeat c. and d. until a holding criterion is reached.

Harmonic Search is a so-called evolutionary algorithm and an advantageous method for solving serious planning problems. A systematic approach would be to try out all possibilities, which is disadvantageously not efficient. However, it is efficient and advantageous to guess any valid solution and to evaluate the suggested solution, which is utilized by evolutionary algorithms. This approach is a trade-off between systematics and efficiency.

The algorithm of the harmonic search contributes significantly to the solution of the above-mentioned object, the algorithm also contributing in particular to the technical character of the invention. The algorithm as such effects, inter alia, a rapid and improved optimization of the building planning (with regard to the computing time of the processor and the quality of the solution produced). Due to the fact that the solutions are evaluated and annotated, solutions that are found to be less good can be deleted under certain circumstances, since these have no benefit in the further course of the harmonious search. This leads to an advantageous reduction of memory resources. Furthermore, due to its simple design and the few method steps, the algorithm requires only low processor capacities of the data processing unit (here: Server device), as a result of which, on the one hand, energy is saved and, on the other hand, several buildings can be planned in parallel.

After all relevant parameters (material-related and/or geometry-related building parameters and/or environment-related parameters and/or parameters relating to the building subunit mix as well as the minimum square meter size and/or maximum square meter size of the at least one building subunit have been initialized, an optimal solution for a building specification adapted to the building area and country-specific building specifications is preferably sought. First, a harmonic memory is preferably set up. The harmonic memory comprises a multiplicity of predefined and/or randomly selected harmonics (solutions). The solutions are then tested and evaluated by the heuristics according to the invention and supplemented by new solutions. Each newly added solution is also evaluated and annotated. Poorly rated solutions receive penalty points. A solution is preferably to be regarded as optimal if it is annotated with no or only a few penalty points.

The one building specification adapted to the building area and country-specific building specifications is defined as the optimal solution of the algorithm of harmonic search. Preferably, the optimum solution is determined by the holding criterion in which the best rated solution (preferably with the fewest penalty points) is selected at the time of the holding criterion.

After each iteration, the algorithm preferably checks whether a harmony (solution or building specification) has been generated without penalty points. Furthermore, the algorithm preferably checks after a certain number of iterations whether the algorithm converges (holding criterion). If this converges (for example after 1000 iterations), the algorithm aborts. In this case, the algorithm checks, in particular, whether the penalty points remain the same for all newly added solutions. If the algorithm converges, a best rated solution can likewise be regarded as optimal. Preferably, optimum solutions are sought with respect to a single aspect of the building to be produced. The optimal solution is also to be regarded as an optimization. In this way, an optimal solution for a building geometry can be obtained. In a parallel optimization, on the other hand, an optimal solution for a building subunit mix can preferably be obtained.

In a further preferred embodiment, the method is characterized in that a plurality of optimizations are carried out in parallel on the server device, the optimization preferably being carried out with reference to abuilding subunit matrix, to a building geometry and/or to a building environment. As a result of the fact that a plurality of optimizations can take place simultaneously in parallel, a building plan is produced much more quickly. In particular, the algorithm makes it possible for a plurality of components of the server device to execute a part of the algorithm at the same time. It goes without saying that the optimizations to a building subunit mix, to a building geometry and/or to a building environment are dependent on the information values, included in the input data set, about material-related and/or geometry-related building parameters and/or environmental-related parameters and/or parameters relating to the building subunit mix and the minimum square meter size and/or maximum square meter size of the at least one building subunit. Accordingly, the optimizations are also dependent on the development area and the country-specific regulations.

An optimization with respect to the building geometry can, for example, represent an optimization with respect to the outline of the building, namely: Height, depth, floor area, roof design, etc. (without being limited to this). This means preferably that the outline is adapted with respect to the building area and/or country-specific specifications and, for example, does not exceed a certain height (possibly prohibited by country-specific specifications), while still retaining sufficient room in the interior of a building, because the building area makes it possible to produce a particularly wide building. In this sense, optimization is preferably to be regarded as a compromise which, among other things, preferably explores the maximum expansions of the building (which depend on the development area and country-specific regulations).

Optimization with regard to the building environment is preferably to be regarded as an optimum design of the building in interaction with the environment, for example cellar constructions, or integration into a rock (without being limited thereto). For example, an elevation on the building surface can be integrated into the building by accessing a room on the elevation via a staircase without the elevation having to be excavated. It can be regarded, for example, as a compromise between processing effort, aesthetics and/or functional benefits. Under the circumstances, for example, deep heat boreholes can be integrated into a building or on the building surface, which reduce energy costs for heating the building (functional benefits).

An optimization with regard to the building subunit mix relates to the various building subunits, which can in each case be optimally arranged and also selected, so that, for example, an advantageous promotion by the state can be obtained. Optimization with regard to the building subunit mix can be the best possible compromise between state funding and housing divisions. Thus, the compromise can be presented in such a way that, for example, a multiplicity of particularly strongly promoted dwellings (building subunit) are preserved, but in the process all the technical boundary conditions of statics are still adhered to or lighting conditions of individual dwellings are also taken into account.

The invention is not limited to these optimizations. Thus, for example, a building can also be optimally optimized for the materials to be used, the size of the building subunit or also construction measures for production.

In a further preferred embodiment, the method is characterized in that the server device is in data connection with a database server, an annotated solution being stored on the database server. Database servers are preferably data processing units on which database systems are stored. The database server provides data management services which can be used by other data processing units (server device and/or client). In larger systems with a high data volume, high-performance mainframe computers are preferably configured as database servers for this purpose, which serve as a node for the flow of information. One advantage is in particular that the data can be secured on the database server in a special way, the already annotated solutions not being lost in the event of a failure of the server device or of the client.

In preferred variants, the database server can furthermore comprise a further backup server which secures all the files of the database server once more, so that even a failure of the database server remains without negative consequences.

The requirements of the harmonious search preferably require a persistent storage of generated building solutions. The collected data can be used in the future to calculate expected values or variance of stochastic random variables. Finally, each solution is annotated by a heuristic that makes it possible to evaluate a solution as good or bad.

In a further preferred embodiment, the method is characterized in that the server device comprises a plurality of servers, the servers being in data connection with one another and cooperatively carrying out calculations. It goes without saying that a server is to be regarded as a data processing unit. Due to the fact that a plurality of servers are connected to one another and cooperate, the server devices can each have different specifications which are optimized for their calculations to be carried out. Thus, for example, particularly computation-intensive steps can be calculated on a server with a high-performance processor, whereas less computation-intensive steps can be carried out on a server with a weaker processor, the latter consuming less energy.

In a further preferred embodiment, the method is characterized in that the client is configured as an entity, where the entity is an Internet-enabled terminal and/or a computer program product installed on a terminal and/or a web application.

The client is configured in particular as a terminal selected from the group comprising: Smartphone, Tablet PC, Desktop PC, Notebook. The interaction of a user (e.g. Owners, architects, site managers, etc.) with the client-server model can take place via various endpoints (clients) - among other things, a website can also be one of these endpoints. Web applications require only one web browser on the user’s computer, which usually already exists. Web applications have the advantage that they can be run on all web browsers, whereby no further installation of software is necessary.

In a further preferred embodiment, the method is characterized in that the output data set comprises data that can be interpreted for a CAD system and the building plan is based on a CAD model. In this case, a 3D building model (CAD model) is preferably created on the basis of modules, from which the building plan is subsequently derived. The various CAD software tools known from the prior art vary greatly from one another, which is due to the manufacturer’s heterogeneity. Therefore, the optimized or adapted building specification is preferably made available in an exchange format of the group comprising PDF, JSON, XML, CSV (output data record) and the translation of the solution into the native data structure is transferred by plugins into the author software. The further advantages of all file formats have already been explained in the course of the input data record and can also be adapted for the output data record. The client preferably has means for processing an output data record with data which can be interpreted for a CAD system, in order to create a building plan from an output data record. This can include, for example, a CAD program.

In a further preferred embodiment, the invention relates to a system for producing a building comprising at least one building subunit, characterized in that the system comprises a client, a server device, a detection device and a workstation,
the client is set up to:
   a. load material-related and/or geometry-related building parameters and/or environmental-related parameters and/or parameters relating to a building subunit mix as well as the minimum square meter size and/or maximum square meter size of the at least one building subunit into a memory;
   b. generate an input data set which includes information content on material-related and/or geometry-related building parameters and/or environmental-related parameters and/or parameters relating to the building subunit mix as well as the minimum square meter size and/or maximum square meter size of the at least one building subunit;
   c. transmit the input data record to the server device;
   d. generate a building plan based on an output data set;
the server device is set up to:
   a. execute a harmonic search algorithm, including the input data set, and generate an output data set, the output data set comprising a building specification adapted to the development area and country-specific building specifications;
   b. transfer the output data record to the client
the workstation is set up to carry out construction work on the building with the at least one building sub-unit, taking into account the building plan,
the detection device is designed to:
   a. Determine and analyse a building area, obtaining the material-related and/or geometry-related building parameters and/or environmental-related parameters and/or parameters relating to the building subunit mix; and/or
   b. Capture, analyse and/or prepare text data with country-specific building specifications, thereby generating the minimum square meter size and maximum square meter size of the at least one building subunit.

Such a system for achieving the above-mentioned object is neither known from the prior art nor suggested to an average person skilled in the art. Rather, the system according to the invention is to be regarded as a departure from the prior art, in which, in particular, the production of a building and the production of a building plan frequently have to be included in manual monitoring, analysis, transmission and/or processing steps. In contrast, the system according to the invention offers the possibility of carrying out an automatically executed method for producing a building and for generating a building plan. Above all, the system also offers the possibility of providing a particularly compact system structure which requires only a few system components and includes all the essential boundary conditions for the production and planning of a building.

A person skilled in the art will recognize that the advantages, technical effects and preferred embodiments discussed in connection with the method according to the invention apply analogously to the system according to the invention for the production of a building comprising at least one building subunit. Likewise, all advantages, technical effects and preferred embodiments which are described in the context of the system can be transferred to the method.

It is preferred in the sense of the invention that the detection means comprises at least one sensor or a sensor system. A sensor can determine physically (e.g. amount of heat, temperature, humidity, pressure, sound field variables, brightness, acceleration) or chemically (e.g. pH value, ionic strength, electrochemical potential, analytical methods, such as e.g. spectral or microbiological) properties and/or the material nature of its environment qualitatively or quantitatively as a measured variable. These variables are detected by means of physical or chemical effects and converted into a further processable electrical signal. In a preferred embodiment, the detection device comprises a sensor selected from the group comprising: Temperature sensor, displacement sensor, pressure sensor (force sensor), acceleration sensor, image sensor, touch sensor, humidity sensor, GPS sensor, NFC sensor, RFID sensor, air quality sensor.

The sensors of the detection device are set up to detect and/or analyse and/or process a development area and/or text data with country-specific construction specifications, preferably automatically, as a result of which parameters are preferably obtained selected from the group consisting of: material-related and/or geometry-related building parameters and/or environment-related parameters, parameters relating to a building subunit mix, the minimum square meter size and maximum square meter size of the at least one building subunit. The combination of all the information preferably results in comprehensive overall information, from which in particular very detailed findings about the development area and the legal framework conditions are obtained.

In a preferred embodiment, the detection device also has a data processing unit. In this case, the detection device can be embodied as a physical unit with the data processing unit, which advantageously minimizes the possibilities of intervention and manipulation on the system from the outside. In addition, a detection device can also be understood as a detection device system which has a multiplicity of sensors for detecting the above mentioned parameters. In a preferred embodiment, the data processing unit of the detection device comprises a memory and a processor. As a result, the detection device can subject the detected information to preliminary processing. This can, for example, have a first analysis or a filtering of the recorded data, as a result of which the client and/or the server device advantageously requires less power for data processing and memory.

In a further preferred embodiment, the workstation is set up to carry out construction measures of the building with the at least one building subunit, taking into account the building plan. Such a workstation can preferably be connected to a data processing unit (preferably wirelessly), which interprets the data of the building plan and can automatically forward control commands to the workstation. The workstation can preferably execute these commands autonomously via means provided for this purpose. However, it can also be preferred for the data processing unit to be able to provide specific command sequences and/or threshold values to a display device which is part of the workstation. Thus, a specialist who actuates the workstation can implement and execute the specifications of a building plan by the specialist following the instructions on the display device.

The data of the building plan as well as the control commands for the workstation are therefore to be determined as a consequence by the output data record. The output data record is therefore still of technical relevance for the system and/or the method for producing a building.

The input data record and the output data record both serve a technical purpose, so that the algorithm of harmonic search is causally linked to a technical effect (namely, inter alia, fast, efficient production of a building taking into account all boundary conditions).

In a further preferred embodiment, the system is characterized in that the workstation is selected from the group comprising: Earth-moving equipment, stationary excavators, mobile excavators, apartment excavators, suction excavators, drilling and trench wall equipment, transport equipment, machines for transporting and processing concrete and mortar, hoists, ramming and pulling equipment, equipment in traffic route construction, sewer and pipeline construction equipment, compaction equipment, tunnel construction equipment, compressor equipment, cleaning equipment. The work station according to the invention is not limited to the work stations included in the group mentioned. The construction equipment described can be controlled autonomously by a control device or data processing unit or can be operated by a human being, whereby partially automated solutions are also possible.

In a further preferred embodiment, the system is characterized in that the server device is set up to execute the algorithm of the harmonic search which represents an optimization and comprises the following steps:
a. Initialization of material-related and/or geometry-related building parameters and/or environmental parameters as well as the minimum square meter size and/or maximum square meter size of the at least one building subunit
b. Structure of a harmonic memory
c. Improvising new solutions
d. Evaluate and annotate the solution and update the harmonic memory
e. Repeat c and d until a holding criterion is reached.

In a further preferred embodiment, the system is characterized in that the server device is in data connection with a database server and is set up
carry out several optimizations in parallel, the optimization preferably being carried out in relation to a building subunit mix, to a building geometry and/or to a building environment;
store an annotated solution on the database server;
wherein the server device comprises a plurality of servers that are data-connected to each other and cooperatively perform calculations.

In a further preferred embodiment, the system is characterized in that the transmission of the input data record, of the output data record, takes place as a data transmission process via an IP-based communication, at least one data transmission process being carried out in a cryptographically protected manner by a security module. This leads particularly advantageously to a tamper-proof production of a building plan and of all information processes.

The IP-based communication preferably takes place via Internet protocols (IPv4, IPv6), that is to say protocols of network communication. The transmission of data via protocols of the network communication advantageously allows a transmission of large amounts of data (TCP, UDP), so that under certain circumstances even the live transmission of video and detailed photo sequences are thereby made possible. In the present case, the protocols are selected from the group comprising https, http, SIP, SFTP, FTP, SMTP.

In a preferred embodiment, the HTTP (Hypertext Transfer Protocol) or HTTPS (Hypertext Transfer Protocol Secure) protocol is used as the transmission protocol. In this context, the input data record and/or the output data record are transmitted as a so-called payload by means of “http”/“https”. An advantage of http/https is that the entities are not burdened with having to maintain a connection over a longer period of time. Furthermore, “HTTP” can be implemented in the system according to the invention in a simple manner without great requirements and, in particular, is extremely user-friendly.

In a further preferred embodiment, the system is characterized in that the client is configured as an entity, where the entity is an Internet-enabled terminal and/or a computer program product installed on a terminal and/or a web application.

In a further preferred embodiment, the system is characterized in that the output data set comprises data that can be interpreted for a CAD system and the building plan is based on a CAD model.

In a further preferred embodiment, the invention relates to a computer program product for generating a building plan which is stored in a medium which can be used in a computer, characterized in that the computer program product is set up
execute a harmonic search algorithm with reference to an input data record and generate an output data record, wherein
   a. the input data set includes an information content about material-related and/or geometry-related building parameters and/or environmental parameters as well as the minimum square meter size and/or maximum square meter size of the at least one building subunit; and
   b. the output data record includes a building specification adapted to the development area and country-specific building specifications;
to transmit the output data record to a client using technical means of a computer.

A great advantage of the computer program product for the generation of a building plan in the sense of the invention is furthermore to be seen in particular in the fact that all substantially relevant parameters (with respect to the environment, material, geometry, regulations, etc.) as well as the individual wishes of a builder or also construction manager, structural engineer, architect, etc., can be included. Ultimately, all entities involved in the construction of a building are included in the planning even before the actual construction and their competences are literally merged with each other.

The person skilled in the art will also recognize for the computer program product according to the invention that the advantages, technical effects and preferred embodiments described above in connection with the method and system can be adapted analogously to the computer program product according to the invention. Likewise, all the advantages arising in connection with the computer program product and can be transferred to the method and the system.

In the case of the present computer program product, in addition to the fact that it is present on a computer, there is, inter alia, a further technical contribution to achieving the above mentioned object. Because the computer program product executes or comprises the algorithm of the harmonic search, the computer program product as such likewise has all the advantages already mentioned above with the algorithm of the harmonic search. The computer program product is preferably used for generating a building plan, the building plan in turn being essential for the production of a building.

In the present case, the computer program product is preferably part of the system according to the invention and/or is likewise suitable for carrying out method steps according to the invention, the computer program product preferably being installed on the server device.

The technical parameters in the input data record preferably do not depend on decisions that a human user has to make. They are preferably generated automatically via the detection and analyses of a detection device. Correspondingly, there is a technical effect in the form of improved time- and resource-efficient production and planning of a building.

In a further preferred embodiment, the computer program product is characterized in that the algorithm of the harmonic search represents an optimization and comprises the following steps:
a. Initialization of material-related and/or geometry-related building parameters and/or environmental parameters as well as the minimum square meter size and/or maximum square meter size of the at least one building subunit
b. Structure of a harmonic memory
c. Improvising new solutions
d. Evaluate and annotate the solution and update the harmonic memory
e. Repeat c and d until a holding criterion is reached.

In a further preferred embodiment, the computer program product is characterized in that the computer program product is set up to transmit annotated solutions to a database server using technical means of a computer and the computer program product is installed on a computer of a server device.

### PREFERRED IMPLEMENTATION FORMS FOR THE INVENTION

In a further preferred embodiment, the invention relates to a computer- and/or network-based method for planning at least one building for at least one predetermined building type and/or predetermined dimensions of the building, comprising at least one building subunit, wherein the method comprises the following steps:
Provision of modules for at least one building type and at least one building subunit type, where the respective modules contain essential technical specifications, parameter ranges for dimensions and/or restrictions for the respective building type and the respective subunit;
Creation and storage of a subunitmatrix for the at least one building subunit type, taking into account the modules for the respective building subunit, the subunit matrix comprising all possible floor plans of the building subunit and associated adapted modules for each floor plan,
Calculation and storage of possible combinations of buildings and building subunits, taking into account:
   i. the modules for the building type and/or the specified dimensions of the building,
   ii. the at least one subunit matrix,
where structural parameters are determined and/or adapted taking the modules into account.

Planning can preferably also be a draft.

A building is, for example, a residential building and/or an office building. A building subunit is preferably at least one piece of furniture, a room, an apartment, a floor and/or a development. A building subunit type is, in particular, a floor type, an apartment type, a development type, a room type and/or a furniture type.

The method advantageously uses at least one outer unit and an inner subunit contained therein, the units being adapted to one another. The outer unit can also be a higher-level subunit (e.g. inner subunit “room”, outer unit “apartment”) or a building. The basic idea is reminiscent of the well-known “mamushka” principle of outer smaller dolls and inner smaller dolls contained therein, which are each adapted to one another in terms of size.

The invention relates to a computer- and/or network-based method for planning or designing at least one residential building for at least one predefined type of building and/or predefined dimensions of the residential building. Said method is carried out using at least one computer and/or a combination of several computers, e.g. in a network.

A type of building preferably describes the basic design of the building, which includes in particular the basic dimensioning, that is to say preferably the ratio between width, height and depth, the number of floors, the use of a flat or sloping roof or the like.

The dimensions of the residential building preferably include the floor area and the height of the building.

The residential building comprises at least one apartment. An apartment is preferably of a certain type of apartment. An apartment type preferably comprises the number of rooms of an apartment. A type of apartment is, for example, a 1-room apartment, a 2-room apartment, a 3-room apartment, a 4-room apartment, a 5-room apartment, a 6-room apartment, a 7-room apartment, an 8-room apartment, a 9-room apartment, a 10-room apartment, an 11-room apartment, a 12-room apartment, a 13-room apartment, a 14-room apartment, a 15-room apartment, etc. Preferably, the bathroom or the kitchen(s) are not counted for the number of rooms. An apartment type can, for example, also include the basic form of an apartment, for example Rectangle, L Type (L Shape). The type of dwelling may also comprise further information such as, for example, accessibility, etc., and components.

A floor preferably comprises at least one shooting and at least one apartment. A floor is preferably a level in a building solution.

Access preferably comprises access routes, entrance areas, components and rooms, via which the users reach the individual user units, such as, for example, apartments or offices, in the horizontal or vertical direction. Supply and disposal routes for deliveries, waste disposal, etc., are also preferably included. Horizontal accesses preferably comprise elements which make it possible to reach all rooms on a continuous plane. Vertical accesses preferably comprise elements which allow access to various floors. Preferably, horizontal and vertical developments are closely linked to one another. Elements of the horizontal development are preferably selected from the group comprising corridor, house corridor, gallery (preferably a room which is longer than wide and has numerous light openings on at least one of its two longitudinal sides), arcade, enfilade (preferably a series of rooms to form a room escape, the door openings lying exactly opposite one another) and/or atrium (preferably a rectangular interior in the middle of the house, from which the surrounding rooms are accessible). Elements of vertical access are preferably selected from the group comprising stairs, ramps, escalators, elevator installations and/or paternoster elevators. A distinction is preferably made between different types of horizontal development: Single-, two-, three-, multiple-channels (four-, five-, six-channels, etc.), central corridor and/or arcade, depending on the number of utilization units which are accessed per floor by the one (preferably vertical) development. The cataloguing type preferably comprises basic information about the cataloguing, such as horizontal or vertical, corridor, stairs, ramp, elevator, accessibility, one-, two-or three-deckers, etc.

The method preferably comprises the provision of modules for at least one type of building, at least one type of floor, at least one type of access and at least one type of apartment, the respective modules containing essential technical specifications, parameter ranges for dimensions and/or restrictions for the respective type. The modules are preferably created separately for each object which is the subject of the method (e.g. residential building/building type, development/development type, dwelling/dwelling type), preferably in advance, and are preferably stored in a matrix. This is advantageously the initialization process of the matrix. Modules are preferably also called control elements.

Technical specifications are preferably selected from the group comprising the material properties of building materials, heat protection specifications (e.g. heat protection ordinance), energy saving specifications (e.g. energy saving ordinance), heat transmission resistance and/or heat transmission coefficient of building materials, static specifications, sound insulation specifications, specifications with regard to moisture transport, specifications with regard to radiation, heat conduction, heat radiation, heat insulation and/or heat protection, building acoustic specifications, sound transmission and/or sound insulation of building materials, fire protection specifications, exposure specifications, transparency of building materials, flammability and/or flammability of building materials, strength specifications, in particular with regard to fracture strength in general, tensile strength, compressive strength, compressive strength, flexural strength, flexural tensile strength, torsional strength, shear strength, strength of building materials, in particular fracture strength in general, tensile strength, compressive strength, flexural strength, torsional strength, torsional strength, shear strength, elasticity specifications, in particular with regard to elasticity module, compression module; and/or shear module; elasticity of available building materials, in particular elasticity module, compression module and/or shear module, specifications for load-bearing walls or non-load-bearing walls, wall thicknesses and specifications with regard to room heights.

Parameter ranges for dimensions preferably include minimum or maximum dimensions of rooms, balconies, accesses, staircase width, stair climb, step width of the staircase, step surface of the staircase, minimum or maximum distances between: Walls and windows, doors and windows, windows one below the other, doors one below the other, doors and walls, doors and ceilings, windows and ceilings, windows and floors, as well as parameters that classify the quality of the room within a previously defined spectrum, including, for example, with regard to furniture.

Restrictions for the respective type preferably include minimum dimensions, minimum distances between windows, doors, walls and/or ceilings, minimum size ratios of windows, doors, walls and/or ceilings, dimensions in different directions from one another of rooms (e.g. the ratio of x to y dimension of a room), minimum or maximum areas of rooms, apartments, developments and/or residential buildings, minimum thicknesses of walls, specifications with regard to exposure areas, geological specifications, etc.

A preferred function of the modules is to make the processing in the method as lean and efficient as possible, and another is to ensure that decisive technical, for example physical, variables are taken into account in the planning process. The modules include, in particular, technical information. Preferably, all relevant information is included, such as, for example, load-bearing walls, non-load-bearing walls, floor structures, doors, windows, rooms, surfaces, equipment. These can be linked to a later component which, however, does not yet contain a 3D geometry. Thus, a large part of the relevant information can advantageously be generated even before a 3D building model is created. The modules preferably comprise parameterised lines which represent, for example, building elements (walls, floor ceilings, windows, doors, furniture, rooms) in a simple graphic manner, on which the equivalent components are applied and aligned in the 3D building model in the further process. The building or partial elements are preferably to be distinguished according to component groups (e.g. walls, floor ceilings, doors, windows, stairs, elevators, furniture, rooms, sanitary objects). However, the lines advantageously also serve for rapid visualization, since they preferably correspond to the plan, in particular in a simplified and/or schematic manner. In this case, a schematic plan view comprises, for example, the basic shape of a plan view (for example, L-shaped) without precise dimensions.

A module floor plan is preferably a floor plan representation of a module (apartment or development), for example, a “apartment module floor plan” is a floor plan representation of an apartment module, a “development module floor plan” is a floor plan representation of a development module, a “floor module floor plan” is a floor plan representation of a floor and preferably of the modules/subunits containing it.

The modules preferably already contain spatial information. Room information comprises utilization area (NUF), traffic area (VF) and technical functional area (TF), which preferably make it possible to evaluate the net room area (NRF). These surface characteristics are preferably defined in accordance with DIN 277-1. The NRF preferably comprises the usable area, the technical area and the traffic area. The VF preferably includes the part of the NRF that serves the access to the rooms, the traffic within the building and also the exit in case of an emergency. Movement areas within rooms are preferably not included. The NUF preferably comprises the sum of the base area with uses (that part of the NRF which serves the use of the building due to its intended purpose). The technical functional area preferably comprises that part of the NRF which is used for the technical installations for the supply and disposal of the building. If, for example, the accommodation of technical installations for the supply of other buildings is intended (e.g. heating house), the required base areas are NUF. The modules preferably comprise a z-direction (in particular height) or preferably a plane in the z-direction. Thus, the volume can preferably also be evaluated. In addition, the spatial information preferably comprises variables which divide the quality of the rooms with respect to the ability to be furnished (for example, maintaining spacing areas and movement areas) within a spectrum defined in advance. The sum of the room qualities in the apartment, the development and in the entire building enables preferably users to recognize the spatial/planning quality when operating the solution in early stages.

The modules preferably also comprise restrictions. Restrictions are preferably lines which are defined, for example, as boundaries for specific regions or components and which serve, for example, as parameters in the method, for example for the solution process in the algorithm. Restrictions can be, for example, surfaces and/or contours of a room, an apartment, a development, a floor and/or a building, which are provided for certain functions, such as, for example, surfaces for exposure, for the development, for fire walls, etc. (e.g. surfaces for circulation, exposure or closed walls). Restrictions are aligned, for example, at the reference planes, in particular of a CAD component family. Restrictions or restriction elements are advantageously based on the same basic principle as all modules and can preferably be influenced by them in their dimensions. The spatial areas occupied by restrictions are preferably defined in the algorithm as dependencies or limitations in the calculation.

The method comprises the creation and storage of a housing matrix for the at least one type of apartment, taking into account the modules for the type of apartment, the housing matrix comprising all possible apartment floor plans and associated adapted modules for each floor plan. The housing matrix can, for example, on the basis of the technical specifications, the parameter ranges and the restrictions of the modules, create all possible housing floor plans under these specifications. The creation can be efficiently limited, for example, in that the apartment floor plans are created only within a predetermined, discrete grid dimension. For example, all possible apartment layouts can be created within the minimum and maximum dimensions, which fall within the preferably predetermined grid dimension. In this case, the modules are preferably adapted to the respective apartment floor plans. For example, parameter ranges for the minimum and maximum dimensions can be omitted, since concrete dimensions within the parameter ranges have now been selected for the respective ground plan and these are therefore no longer required. Other modules are preferably adapted only to the specific implementation.

For example, a grid of 12.5 cm × 12.5 cm can first be defined for the development of the ground plan sizes. In steps within this grid, the dwelling sizes can preferably expand on the X and Y axes (the horizontal plane). Preferably, likewise already known and/or precalculated floor plan types can be imported and preferably adapted to the preferably predetermined grid dimension.

For the types of dwelling on which the further method is based, the parameters (characteristics) of the minimum and maximum expansions (in each case both in the X and Y directions) are preferably determined. This is preferably done automatically by enlarging or reducing the floor plans along the grid dimension, for example in the CAD program.

The permissible tolerance range for the possible development of the room sizes can preferably also be based on a known housing evaluation system. Different or new criteria can also be used with regard to the apartment dimensions

The determined expansion parameters and thus all associated parameters such as room sizes and room qualities can preferably be mapped into lists within the CAD program. Therein, the types of dwelling are preferably grouped into types and recorded with their expansion values (according to X and Y axes). In the matrix, all characteristics are preferably mapped or stored which, for example, do not fall below or exceed the predetermined tolerance ranges (for example minimum or maximum overall size), correspond to the technical specifications, etc. The results are preferably subsequently transferred into a characteristic table. The terms expression table, expression matrix and housing matrix are preferably used synonymously in this document.

The creation and storage of a subunit matrix for the at least one building subunit type is preferably included, taking into account the modules for the respective building subunit, the subunit matrix comprising all possible floor plans of the building subunit and associated adapted modules for each floor plan. The subunit matrix is preferably a furniture matrix, a room matrix, a housing matrix, a development matrix and/or a floor level matrix. Thus, the above-described creation and storage of a subunitmatrix means, for example, the following:
Creation and storage of a housing matrix for the at least one type of apartment, taking into account the modules for the type of apartment, wherein the housing matrix comprises all possible apartment floor plans and associated adapted modules for each floor plan,
Creation and storage of a development matrix for the at least one developmenttype, taking into account the modules for the developmenttype, wherein the development matrix comprises all possible development floor plans and associated adapted modules for each floor plan,
Creation and storage of a floor level matrix for the at least one floor leveltype, taking into account the modules for the floor leveltype, the floor level matrix comprising all possible development floor plans and associated adapted modules for each floor plan.

Threshold value parameters can preferably be determined or adapted during the creation, for example, of the housing matrix. These are preferably dependent on the minimum or maximum parameters and determine, for example, what distance (separating) walls have from one another and from which extent of a plan (separating) walls are displaced. This determination or adaptation of threshold value parameters is preferably encompassed by the adapted modules encompassed by the housing matrix for each floor plan.

As another example, the following steps can be included:
Creation and storage of a room matrix for the at least one room type, taking into account the modules for the room type, the room matrix comprising all possible room floor plans and associated adapted modules for the furniture and/or
Creation and storage of a development matrix for the at least one development type, taking into account the modules for the development type, the housing matrix comprising all possible development plans and associated adapted modules for each apartment and/or
Creation and storage of a floor level matrix for the at least one floor leveltype, taking into account the modules for the floor leveltype, wherein the floor levelmatrix comprises all possible floor level floor plans and associated adapted modules for each development,
Creation and storage of a building matrix for the at least one buildingtype, taking into account the modules for the buildingtype, the buildingmatrix comprising all possible building floor plans and associated adapted modules for each floor.

In this example, the calculation and storage of possible combinations of developments, apartments and/or residential buildings can also preferably be carried out taking into account the development matrix of the at least one predefined development type and/or the building matrix of the at least one predefined building type.

The creation and storage of the development matrix and/or the building matrix preferably takes place analogously to the creation and storage of the other subunit matrices, for example the housing matrix. If matrices are available both for the apartments, developments, floors and/or buildings, the subsequent calculation and storage of the possible combination preferably comprises a type of “matching process” of the respective adapted modules. In this way, the calculation and storage can be further simplified and made efficient.

All possible combinations are preferably retained in the matrix and advantageously serve as the basis for the solution calculations in the algorithm (for the calculation and storage of possible combinations, see below).

Before the calculation starts, for example, all types of apartments with their characteristics (expansions in the X and Y directions) are preferably initialized. That is to say, the matrix is set up in an automated manner using a script by placing and modifying the modules.

The initialized floor plans can preferably each be stored as a text format in a JSON file (JavaScript Object Notation – JSON). The JSON files are preferably assigned to the apartment categories and are collected according to named file folders. Depending on the type of dwelling, the associated parameters to be evaluated can preferably be generated and likewise created in a second JSON file.

A possible construction phase (or a residential building to be built there), which is to be filled with dwellings, is preferably also initialized before a further calculation. The construction phases, construction areas and/or residential buildings can be defined according to the specifications of the planner. If various possible subdivisions of a construction site are specified, then all construction sites and/or residential buildings to be resolved are preferably initialized and stored, for example, as a JSON file. A construction site preferably determines the (buildable) area of the plot of land on which a building is to be placed. A construction area can be present on the property several times.

The initialization of dwellings and construction sections, building plots and/or residential buildings is preferably carried out by means of modules. These advantageously have a very small data volume, as a result of which the computing time in the initialization process can preferably be kept low. This is particularly advantageous since the housing, development, floor and/or building matrices can contain, for example, 10,000 variants or more, depending on the module category.

The initialization is preferably carried out only once and can then be taken over at least partially (for example with adaptation of the technical specifications and constructional parameters), in particular for various construction sites or residential buildings to be built. Only completely new housing, development, floor and/or building types have to be completely reinitialized.

Predefined parameters and evaluation criteria can be illustrated in a catalogue or floor plan manuscript.

The matrices are preferably stored in a data memory. This can preferably be a cloud-based database.

The calculation and storage of possible combinations of buildings and building subunits includes, for example, the calculation and storage of possible combinations of buildings and furniture, rooms, apartments, developments and/or floors.

Also preferably included is the calculation and storage of possible combinations of developments, apartments and/or residential buildings, taking into account, for example:
i. the matrix for the building type and/or the specified dimensions of the residential building,
ii. the control elements and/or matrix of the at least one predetermined development type and/or
iii. the housing matrix and/or matrix of the at least one given type of apartment,
iv. preferably the matrix of the at least one predetermined room type,
where structural parameters are determined and/or adapted taking the modules into account. This means preferably that the apartments, developments, floors and/or buildings in the matrices are used and all possible combinations of residential buildings are combined with all possible apartments and developments contained therein. The specifications are taken into account by the modules of the building type, the specified dimensions of the planned residential building(s) and/or the modules of the developments. These preferably specify the possible combinations of apartments, developments and residential building(s). For example, only certain dwellings of the housing matrix and, for example, only certain developments of the development matrix on the basis of compatible dimensions of the dwellings with respect to the housing building and on the basis of compatible modules of the housing matrix and the building type come into consideration for a residential building which is predetermined together with dimensions and modules. In addition to technical specifications, the modules of the building type can contain, for example, specifications and information about the number and type of 1-room apartments and 3-room apartments, which means that only those apartment layouts and modules that meet these specifications can be considered. These specifications are preferably again contained in the modules of the housing matrix. In this case, structural variables are preferably adapted accordingly. These include, for example, final values with regard to the material properties of building materials, wall thicknesses (wall thicknesses) and/or room heights for the respective planned residential buildings, etc. For example, modules which include technical specifications with regard to fire protection and further with regard to possible building materials and their flammability can lead to a determination of certain building materials at certain points of the dwelling/residential building in order to comply with the technical specifications with regard to fire protection.

It may be preferable that matrices are also created in advance for residential buildings and developments, which are used in this process (see below). Otherwise, all possible designs of developments and buildings are preferably included in the calculation, depending on the specifications.

Furthermore, a visual representation of essential parameters of calculated dwellings, developments and/or residential buildings and/or the creation of a 3D model with calculated dwellings, developments and/or residential buildings can preferably be included.

The preferred algorithm for the calculation is written, for example, in C#. The aim and function of the algorithm is preferably the calculation of all mathematically possible combinations in a building (preferably taking into account the modules) which result from the underlying dwelling types and the development types with their respective characteristics (preferably predetermined by the modules and/or floor plans). In this case, the algorithm is limited, for example, by the restrictions stored in the modules. The combination of dwellings and developments with the respective characteristics preferably leads to an exponential increase in the possible solutions. All possible solutions are preferably calculated, irrespective of whether they are selected in a possible evaluation carried out later or are omitted. Depending on the desired mix of apartments, this can mean, for example, that all or only certain apartments (or types of apartments) are taken into account in the calculation. When a solution has been calculated, it is preferably compared which characteristic of an apartment can be used in the construction phase. For the evaluation, this file is preferably attached to the solution with its associated parameters. For example, the files are collected as JSON files in a file folder. They are preferably sorted according to construction sections, in each case with the solutions contained and the files of their parameters to be evaluated. For the visualization and evaluation of the files, the result is preferably additionally stored as a CVS file (Comma-separated values file).

The preferred planning software is preferably a technology branch of Autodesk comprising several planning products for architects, building technicians and structural engineers. Revit, for example, is preferably not based on AutoCAD, but contains its own graphics core. While, for example, Autodesk, AutoCAD does not work component-oriented, Revit supports, for example, the technology BIM (Building Information Modeling). The principle of Revit is preferably to support both 2D and 3D modelling of a component-oriented building model.

When a change is made in the planning process, it is preferably also carried out automatically throughout the entire project, so that drafts and documentation preferably always remain consistent and complete.

The following software is preferably used: CAD - Software Autodesk Revit with the addition of the graphical programming interface Dynamo and the additional application Pyrevit, ceapoint Desite, Microsoft Excel, PowerPoint, Word, Outlook, Microsoft Power Bl, Adobe Illustrator, Photoshop, InDesign, RIB iTWO, Microsoft Visual Studio, c# and/or Dynamo as a graphical programming interface.

The following file and transfer formats are preferably used: rvt, .rte, .rfa, .rft, .dyn, .ifc (Revit), .dwg, .dxf (Autocad, Nemetscheck), .ai, .psd, .indd (Adobe), .json (exchange format), .docx, .xlsx, .ppt, .xml, .csv (Microsoft), .dll, .dfn (program libraries), .rpz, (RIB iTWO), .pvs, .cpa, .cpixml, .prg.xml (ceapoint desite).

The following is preferably used as the transfer format:
Data entry ‘Housing mix generator’: DWG/ RVT for modelling (apartments/development groups/ buildings) XLSX for feeding the expression matrix into Dynamo
Data output according to CAD ‘Revit’ - Creation of 3D model: After database access, an Excel file is imported from Power Bl. This is imported into Dynamo and used to create the Revit model.
Data output after ‘Desite MD’ - model preparation and evaluation: This is passed to ‘Desite MD’ for evaluation as CPIXML.

By means of the method, for example, an automatic creation of the apartment floor plans can also be created on the basis of a housing evaluation system (e.g. HoWoGe), e.g. for 2-room, 3-room, 4-room and 5-room apartments. Likewise, a ground floor, a roof (e.g. flat roof) and/or a foundation can preferably be created automatically. Components for the roof, wall, floor incl. Component information can be created. In addition, 3D building models can preferably be created and plans can be output.

The component information stored in a building model can preferably also be used for the mass determination, the calculation or the construction schedule. The processing of the information stored in the building model takes place in a further process step. For this purpose, the building model is transferred via an add-on′ from the CAD program ‘Revit’ to the software ‘Desite MD’. ‘Desite MD’ serves as an intermediate step before transferring the component information to the Ava interface and at the same time to ensure the model quality. The geometry imported into ‘Desite MD’ is automatically subjected to a quality / collision check via a form created there.

Thanks to the method, residential buildings can be created flexibly, efficiently and quickly according to customisable specifications, which meet technical requirements with regard to sound insulation, thermal insulation, incidence of light, fire protection, stability, statics, energy consumption, etc.

The computer or network-based methods can be used to calculate all the implementations possible with respect to the modules in the shortest possible time and also to process large amounts of data.

A further goal is, for example, to create floor plans, sections and views automatically from the process in accordance with the requirements of the respective planning phase. Basic static properties such as maximum spans and load-bearing / non-load-bearing components have preferably been taken into account in the development and have already been applied, for example, in the development modules, control elements, modules and/or components. The dimensioning, e.g. for floor ceilings, staircase cores and exterior walls, is preferably already included (e.g. in the [adapted] modules) or is calculated for the standard case. This preferably also applies to the component dimensioning within the dwellings. The formwork and reinforcement plans are preferably likewise produced on the basis of the building model, for example by taking account of the control elements.

The automated planning of plots of land, taking into account urban planning aspects, is also preferably included in the process. These aspects can preferably be covered in the modules.

An exemplary embodiment of the invention comprises a computer- and/or network-based method for a planning and/or one of at least one residential building for at least one predetermined building type and/or predetermined dimensions of the residential building, comprising at least one dwelling, at least one development and a building, the method comprising the following steps:
Provision of modules for each
   at least one type of building,
   at least one type of storey,
   at least one type of development,
   at least one type of apartment and
   at least one room type,
   where the respective modules contain essential technical specifications, parameter ranges for dimensions and/or restrictions for the respective type;
Creation and storage of a room matrix for the at least one room type, taking into account the modules for the room type, wherein the room matrix comprises all possible room floor plans and associated adapted modules for each compatible furnishing,
Creation and storage of a housing matrix for the at least one type of apartment, taking into account the modules for the type of apartment, wherein the housing matrix comprises all possible apartment floor plans and associated adapted modules for each compatible room,
Creation and storage of a development matrix for the at least one development type, taking into account the modules for the development type, wherein the development matrix comprises all possible development plans and associated adapted modules for each compatible apartment,
Creation and storage of a floor level matrix for the at least one floor level type, taking into account the modules for the floor level type, wherein the floor level matrix comprises all possible floor level floor plans and associated adapted modules for each compatible development,
Calculation and storage of possible combinations of floors, developments, apartments, rooms and/or residential buildings, taking into account:
   i. the modules for the building type and/or the specified dimensions of the residential building,
   ii. the modules of the at least one predefined floor level type
   iii. of the modules of the at least one predefined development type
   iv. the modules of the at least one given type of dwelling and/or
   v. modules of the at least one specified room type,
   where structural parameters are determined and/or adapted taking the modules into account, and;
preferably visual representation of essential parameters of calculated dwellings, developments and/or residential buildings and creation of a 3D model of calculated dwellings, developments and/or residential buildings.

In a preferred embodiment, in the case of a plurality of building subunits, the calculation and storage of possible combinations of buildings and building subunits are carried out stepwise in an order from the smaller to the larger subunit,

wherein the combination of the at least one subunit with the building is calculated last and for each calculation, the calculation and storage of the next smaller subunit is taken into account. It is thus an iterative process as described, for example, in the first figure. The storage can take place, for example, in a subunit solution matrix, which is then used in the next calculation step. Thus, in each case preceding calculations of combinations of building subunits are also taken into account in a calculation step of a larger building subunit.

By way of example, the method is described below with reference to a number of building subunits:
In an exemplary first step, the room matrix is created with at least one room type, but preferably with a plurality of room types, taking into account the modules for the room type. The room types can preferably comprise certain desired characteristics of a room. The room matrix comprises all possible characteristics of these room types and thus associated adapted modules for each floor plan of the apartment.
In one step, for example, the housing matrix is created with at least one type of apartment, but preferably with a plurality of types of apartment, taking into account the modules for the type of apartment. The types of apartments can preferably comprise certain desired characteristics of an apartment. The housing matrix then includes all possible characteristics of these apartment types and thus associated adapted modules for each floor plan.
Matrices for the development type and the floor level type are also preferably produced.
In the following step, all possible combinations of apartments in the housing matrix and rooms from the room matrix are calculated and stored in the apartment solution matrix. A solution in this matrix is composed of an expression of an apartment type, of the housing matrix and of the compatible, jointly or possibly alone fitting expressions of the room types from the room matrix.
Thus, the method is then continued at the next larger building subunit level until finally all combinations of the building subunits and the building have been calculated and stored.

In a preferred embodiment of the invention, constructional variables are selected from the group of span of a ceiling, thickness of a ceiling and/or include the requirement and/or positioning of a truss, which are calculated taking into account wall structures, wall thicknesses, wall materials, ceiling spans, the positioning of fire walls and/or the positioning of load-bearing walls.

The thickness of the ceiling can be, for example, the thickness of a floor level ceiling.

A truss is preferably a carrier or the like which receives the load of a ceiling, a sheet or a wall and conducts it to other components. The load-bearing capacity or the span of a blanket or a sheet can thus be increased by using a truss.

Thus, these decisive structural parameters can advantageously already be integrated in the planning phase.

In a further preferred embodiment of the invention, structural variables are selected from the group comprising dimensions and/or positions of:
Sub-units and/or buildings and/or
dimensions and/or position of: Doors, lighting surfaces and/or window surfaces, preferably of the buildings and/or subunits.

For example, structural dimensions and/or positions of: apartments, floors, developments and/or residential buildings.

For example, structural variables can be selected from the group comprising dimensions and/or positions of:
Dwellings, developments and/or residential buildings and/or
dimensions and/or position of: Doors, lighting surfaces and/or window surfaces.

These structural parameters contribute particularly advantageously to statics, exposure and efficient use of living room.

In another preferred embodiment of the invention, the method further comprises the following steps:
Visual representation of essential parameters of calculated subunits and/or buildings and/or creation of a 3D model of calculated subunits and/or buildings.

Sub-units are, for example, apartments, developments and/or floors, buildings are, for example: Residential and/or office buildings

Thus, for example, the visual representation of essential parameters of calculated dwellings, developments, floors and/or residential buildings and/or the creation of a 3D model of calculated dwellings, developments and/or residential buildings is included.

For example, the above CVS files with the collected solutions can be read into a software for visualization and interaction. Advantageously, all solutions can be made visible with the program. The parameters NUF, VF, TF are preferably also displayed in such a software and can be, for example, filters for solutions (see below). The results can preferably be limited between minimum and maximum values, and the sum of the possible solutions can advantageously be correspondingly reduced in this way. The calculated solutions can be visualized, for example, either according to the NUF, VF, TF or a flexible interaction of all three surface types. The final solutions, which are preferably selected or filtered for further processing, can preferably be read out again as a CVS file via such software and preferably transferred into a CAD program.

In order to create a 3D model, the transfer of the solutions into a CAD program as well as the joining of the geometric models to form the 3D model can preferably take place fully automatically or partially automatically. The structure of the model, which advantageously requires a plurality of steps, runs automatically, for example, by supporting scripts. The CVS files which have been read in can preferably be used to extract from the script which construction site was used as the basis for calculating the solution and which apartment(s) or which development group was/were used in a solution. By means of a preferred readout of the JSON/CVS files, the modules belonging to the solution with their defined characteristics are preferably automatically taken from the script, preferably imported into the CAD program (e.g. Revit) and preferably automatically placed on the corresponding floor plan level. The preferred modules for the roof and the foundation are preferably calculated separately and advantageously supplemented automatically on the corresponding ground plan levels. From this point onwards, the building (floor plans) can be assessed by a planner, since a 2.5D building has now been built. A further script preferably analyses and interprets the modules, in particular assigns the corresponding system families or components from the CAD program to the modules, and preferably places them, preferably predetermined by the modules, on the corresponding ground plan levels. The building model generated in this way already contains all the information which is preferably required for the preparation of planning documents, such as, for example, floor ceilings with floor structures, walls with windows and doors, rooms, façade cladding, etc. Inscriptions and dimensional chains are preferably to be entered via the CAD program and/or are entered automatically.

The method can be based, for example, on BIM-capable software and AVA. In addition, the method is preferably based on a specially programmed algorithm which preferably accesses a database via a specially developed process chain. The database to be built up in the development process can, for example, have a multiplicity of possible forms of housing, development and building types and permit their combination with one another. Advantageously, from the large number of possible combinations, the suitable forms of development, apartment layouts and the desired residential mix of a residential building (e.g.: Floor apartment building) on a given and suitable plot area.

In a further preferred embodiment of the invention, the building subunit comprises at least one access point, a floor, an apartment, a room and/or a piece of furniture.

In a further preferred embodiment of the invention, the possible combinations are stored in a graph database which permits queries with respect to any desired combinations of subunit types, dimensions of the building and/or structural variables and can output suitable combinations.

Dimensions of the building are, in particular, dimensions of the residential building.

Thus, for example, the possible combinations are stored in a graph database, which permits inquiries with respect to any desired combinations of apartment types, development types, floor types, building types, dimensions of the residential building and/or constructional variables and can output suitable combinations.

A graph database (or graph-oriented database) is preferably a database which uses graphs to store highly networked information. A graph preferably comprises nodes and edges, the connections between the nodes. Preferred concepts for graph databases are the Resource Description Framework (RDF) and Labeled-Property Graph (LPG).

In a labelled property graph or simply property graph, both nodes and edges preferably have properties, also called properties (e.g. weight: 12 kg, colour: Blue, Name: Charlie).

In the RDF (Resource Description Framework), graphs are preferably modelled using triples and quads. Triples preferably comprise three elements in the form of node-edge nodes, which represent a complex graph. Quads preferably extend triples by additional context information, as a result of which triples can advantageously be more easily combined into groups.

Graph databases preferably offer a series of specialized graph algorithms to simplify complicated database queries. Thus, for example, they offer algorithms to find patterns (graph patterns), to traverse graphs, i.e. to find all direct and indirect neighbours of a node, to calculate shortest paths between two nodes, to find known graph structures such as cliques, for example, or to identify hotspots of particularly strongly networked regions in the graph.

For example, the stored CSV files are stored in a graph database. The graph database can map highly networked data structures and make the dependency among the data graphically visible. The advantage over a relational database is, in particular, the maintenance of the stored files and of the database itself. If further parameters, evaluation criteria or new floor plan variants for calculating an overall solution are added in the course of the calculations, the changed data can advantageously be simply added to the graph database. Advantageously, in contrast to a relational database, adjustments of tables, rows & links do not have to be updated. Existing connections & IDs remain preferentially present in the graph database and are merely supplemented with new information. Thus, analysis/evaluation criteria of third-party customers can also preferably be simply appended to the graph database. Thus, for example, new analyses and queries of the database can be carried out again and again on a case-specific basis without this data having to be completely regenerated again and again in advance.

In addition, the graph database preferably offers a flexible interrogation depth. Thus, simple queries can be made, such as how many solutions of an entire building are available with a rectangular 2-room apartment and 3 4-room apartments. In addition, however, this query can also be carried out in many stages, such as: how many solutions of an entire building are there with a rectangular 2-room apartment and 3 4-room apartments, of which 2 of the 4-room apartments have a shower bathroom and one 4-room apartment has a bathtub bathroom? And the quality factor for the 2-room apartment is min. 0.92. (The quality factor indicates how well the apartment meets the evaluation criteria of the Howoge, see below. However, the evaluation criteria can be adjusted. The Howoge criteria serve only as an example.)

In a further preferred embodiment of the invention, the subunit matrix comprises at least one threshold value parameter which comprises distances to be maintained between walls and/or threshold values of expansions of the subunit floor plan in the x and/or y direction from which a displacement of walls takes place.

The subunit can be, for example, an apartment. Thus, for example, the housing matrix and/or the modules for at least one type of housing comprises at least one threshold value parameter which comprises distances to be maintained between walls and threshold values of expansions of the floor plan of the housing in the x and/or y direction from which a displacement of walls takes place.

In particular, in the preparation of the housing matrix and/or calculation and storage of possible combinations of developments, apartments and/or residential buildings, housing floor plans which correspond to actual housing needs can thereby be designed very simply.

In a further preferred embodiment of the invention, structural variables comprise the positioning of an apartment partition between two apartments and/or the positioning of an outer wall on an apartment building outer surface,

depending on the modules, the outer wall can preferably be designed as a normal outer wall with exposure surfaces or as a closed fire wall.

Specifications with regard to exposure areas and/or fire protection in particular can thus be implemented in a simple manner.

In a further preferred embodiment of the invention, the modules of the residential type comprise elements selected from the group consisting of:

Information, parameters and/or restrictions on the floor plan of the apartment; information, parameters and/or restrictions on an orientation and/or position of interior walls as a function of the floor plan; information, parameters and/or restrictions on an exposure area of rooms; information, parameters and/or restrictions on a size of doors and/or a distance from shell openings to adjacent walls; information, parameters and/or restrictions on a shaft dimension and/or a window area and/or specifications for an area evaluation according to DIN 277.

Thus, in the preparation of the housing matrix and/or calculation and storage of possible combinations of developments, apartments and/or residential buildings, the corresponding variables can be taken into account and implemented in a particularly simple and efficient manner in the planning process, without these variables having to be entered or corrected separately for each draft prepared. As a result, certain ideas and specifications, which are to apply, for example, in principle or to a certain type of dwelling or building, can advantageously be taken into account in the automated production of the designs; as it were, the designs can be designed individually.

In a further preferred embodiment of the invention, the modules of the building type comprise dimensions, outer wall structures, outer wall types, roof types and/or cellar types.

As a result, these specifications can be implemented automatically, without having to be specified individually for each design or having to be adapted afterwards.

In a further preferred embodiment of the invention, when the subunit matrix is produced, the possible subunit floor plans are produced by variation within a predetermined grid dimension, which is preferably 12.5 cm.

For example, when the housing matrix is created, the possible apartment layouts are produced by variation within a predetermined grid dimension, which is preferably 12.5 cm.

This grid dimension has proven to be particularly advantageous for the method; in particular, this results in a high degree of individuality and flexibility with respect to the floor plans, without a long computing time being required when carrying out the method and/or an excessively large number of designs being produced which could overwhelm the user.

In a further preferred embodiment of the invention, the housing matrix comprises a surface characteristic value according to DIN 277 and/or DINs following in the future for each housing plan produced.

It is thus advantageously possible to produce designs which can be customised and at the same time can be compared across processes.

In another preferred embodiment of the invention, the method further comprises the following steps:
Creation of an assessment catalogue for apartment floor plans;
Evaluation of each apartment plan created in the housing matrix on the basis of the evaluation catalogue;
Prefers to select suitable apartments from the apartment floor plans based on the reviews.

Preferably, a list of evaluation criteria, comprising at least one evaluation criterion, is set up in the evaluation catalogue. The apartment floor plans and/or the (preferably adapted) modules are then preferably compared with the evaluation criteria and an evaluation is carried out. Advantageously, the evaluation is more positive, the smaller the discrepancy between the evaluation criteria and the apartment floor plans and/or the modules. Likewise, a list with all possible values of the apartment floor plans and/or the control elements can be included in the evaluation catalogue, which list includes a corresponding score for the evaluation for each value. Advantageously, a higher score corresponds to a better score; it may also be preferred that a lower score corresponds to a better score. A selection based on the evaluation preferably corresponds to a selection based on a good or better evaluation. In this case, a ranking list can advantageously be created on the basis of the evaluations and the selection can be made in accordance with the ranking list. The evaluation criteria may comprise technical variables such as, for example, fire protection, in particular technical specifications and/or constructional variables, but also variables which are primarily related to the living comfort, such as, for example, the availability of room, incidence of light, (usable) living room, etc. It is also possible to use known evaluation criteria, such as, for example, from the HoWoGe.

The overall assessments of an apartment floor plan are preferably composed of (partial) assessments of the rooms contained in it. The evaluation is carried out, for example, in accordance with the rules specified in advance in the catalogue. The rules can preferably be coordinated and/or defined in advance. Depending on the database query, different best solutions can preferably result.

The evaluation preferably ignores the later placement of the apartment in the building (e.g. the connection to the development), so that an optimal starting position is preferably assumed when feeding in new floor plan or development types, so as not to distort the evaluation in advance.

Some embodiments of evaluation criteria, in particular with regard to living comfort, are listed below by way of example. However, these are to be understood as being literally exemplary. For example, the HoWoGe evaluation catalogue can be the basis for the evaluation.

### Questioning the Standards Defined (in the HoWoGe Catalogue)

In justified cases, it is preferable to deviate there from.

1. (Children)Rooms are subordinate in their dimensions to the bedroom. Here, the use of the rooms should be questioned and it should be considered whether the hierarchy should not be the other way around.

2. The kitchens are located in the least exposed areas. Here, it should be questioned how much light individual areas of use require and whether, for example, a sofa in the low-exposed area would be correct.

3. Should there be a piece of furniture for the TV with the associated module sizes in the living room or is it more sensible to provide a wall surface (wall mounting)? This could also be in the bedroom, for example.

4. Is the wardrobe also conceivable as (built-in) furniture in the hallway? And can you reduce the area in the bedroom?

### Possible Evaluation Criteria for the Objective Consideration of the Individual Rooms

The evaluation could take into account functional staggering in order to assess the quality of the room and furniture. (Especially related to the kitchen)

For rooms, the number of corners could be determined. This gives you an impression of whether the room is angled. The extent to which this has a positive or negative impact on quality still has to be assessed (cabinet niches).)

### Notes on Floor Plan Dependencies

### Kitchen Furniture

The HoWoGe catalogue provides that kitchens (also in L-shape) are always equipped with a rectangular movement surface, which completely fills the area between the two legs of the L’s. This may be due to the idea that a two-line kitchen could also be located in the same area. This massively restricts the furnishing. Therefore, it must be checked and decided whether this requirement is deviated from.

### Plots

It must be clarified whether passages departing from the hallway without a door to the kitchen-living room, are counted in the area considered as the hallway or the living rooms.

### Bathrooms

The opening direction of the doors depends on the design. There is no binding requirement for this. In a further preferred embodiment of the invention, control elements, housing matrix, the possible combinations of developments and dwellings and/or structural variables are stored in the form of a JSON file and/or CSV file.

### Rules Catalogue

The aim of the floor plan evaluation is to sort the results of the generator. For this purpose, rules are drawn up that make it possible to evaluate floor plans objectively (and in a machine-readable manner). These rules can influence each other and, if necessary, also exclude each other. For this purpose, the rules must be weighted. This is not universal, but can vary depending on the project objective.

The rooms and not entire apartments are assessed in each case. The appraisal of the apartment arises from the sum of its rooms.

The rules are defined according to the following order:
1. Usage-independent rules:
   These rules apply to all rooms.
2. Usage-specific rules:
   These rules distinguish according to the use of room.
3. Special rules:
   These rules are tailored to the rooms in the respective apartment configuration.

The catalogue is also structured in this way.

### Usage-Independent Rules

1. Rooms should be as small as possible. (observing the following rules) However, the minimum and maximum sizes must not be undershot or exceeded.

2. Rooms should be equipped with the furniture modules specified by the HoWoGe catalogue. Only the movement surfaces may be superimposed here.

3. Spans over 6.5 m should not be exceeded for an optimized design. However, it is possible to work with larger spans and to adapt the construction accordingly.

4. Sufficient exposure must be ensured.

5. Doors should have a stop of 12.5 cm on both sides to ensure installation.

6. Furniture should not restrict the windows. This means that both the light should penetrate unimpeded into the room, but also that the windows can be opened unrestrictedly. It follows from this that there are generally no furniture in front of floor-to-ceiling windows, only furniture in front of windows with parapet which is not higher than the parapet height.

Further examples of usage-specific rules are given below with reference to some illustrations.

The above-described embodiment has the particular advantage of a preferably (partially) automated selection of apartment layouts on the basis of predetermined criteria. Thus, the selection efficiency from a preferably large number of floor plans can be improved.

In a further preferred embodiment of the invention, modules, subunit matrices and/or structural variables are stored in the form of a JSON file and/or CSV file.

These file formats can be handled particularly easily and efficiently, require a low storage capacity and are particularly compatible with a large number of platforms or software and hardware solutions.

In a further preferred embodiment of the invention, modules, subunit matrix, the possible combinations of subunits and/or structural variables are read in by a CAD program component and the 3D model of the calculated subunits and/or buildings is produced on the basis of these.

This improved embodiment is already described above and offers improved design support.

In a further preferred embodiment, the invention relates to a computer program product which is adapted in such a way that it carries out the method according to one or more embodiments of the description or illustrations.

The average person skilled in the art will recognise that technical features, definitions and advantages of preferred embodiments of the method according to the invention also apply to the computer program product according to the invention.

In a preferred embodiment of the invention, the computer program product is configured in such a way that, when program steps are executed, all available processor cores are used and/or use of the main memory is adapted to the size of the main memory.

Preferably, the programmed algorithm comprises instructions that define that the calculations run on a plurality of processor cores, if the hardware provides this. In addition, it is preferably programmed into the code that the working memory is to be used almost completely. Full utilization can preferably never be achieved, since a certain part is always reserved for the operating system. If the hardware provides, for example, 32 GB of memory, these are used to the fullest extent possible. If this working memory is expanded, for example by a further 32 GB, these are also included in the calculation. Preferably, all available processor cores and/or the main memory are also optimally utilized when distributing the program to a plurality of (web) servers. In this case, the use between the servers can preferably also be adapted and optimized during the method, for example also on the basis of network criteria such as transmission rates between the servers and/or (preferably local) network utilizations.

In a further preferred embodiment, the invention relates to a computer-readable data carrier which comprises a computer program product described in this document.

The average person skilled in the art will recognize that technical features, definitions and advantages of preferred embodiments of the method according to the invention and of the computer program product according to the invention also apply to the computer-readable data carrier according to the invention .

It can be, for example, a DVD, a CD and/or a USB stick. In particular, it is a server application that is hosted within a web server and then writes/stores it in a database. Preferably, it is a graph database and/or an SQL database

### DETAILED DESCRIPTION

In the following, the invention will be described in greater detail using examples but without being limited to these.

### BRIEF DESCRIPTION OF THE FIGURES

FIG. 1 Schematic representation of the method.

FIG. 2 Representation of furniture modules.

FIG. 3 Illustration of an embodiment of a room module.

FIG. 4 Representation of the room matrix.

FIG. 5 Illustration of a characteristic of an apartment module.

FIG. 6 Representation of a housing matrix.

FIG. 7 Representation of a housing-solution matrix.

FIG. 8 Representation of a result from the housing solution matrix.

FIG. 9 Illustration of a characteristic of a development module.

FIG. 10 Illustration of a development matrix.

FIG. 11 Illustration of a development solution matrix.

FIG. 12 Representation of a result from the development solution matrix.

FIG. 13 Illustration of an embodiment of a floor level module.

FIG. 14 Illustration of a floor level matrix.

FIG. 15 Illustration of a floor level solution matrix.

FIG. 16 Representation of a result from the bullet-solution matrix.

FIG. 17 Representation of the building solution matrix.

FIG. 18 Representation of the surface for filtering, sorting and selection from the building solution matrix.

FIG. 19 Representation of a result (the selected one) from the building solution matrix.

FIG. 20 Representation of the solution import result.

FIG. 21 Representation of a 3D building model automatically generated from the modules.

FIG. 22 Representation of planning documents automatically generated from the generated 3D building model.

FIG. 23 Representation of a flowchart of calculations on a server device

FIG. 24 Representation of a preferred server-client model

### DETAILED DESCRIPTION OF THE FIGURES

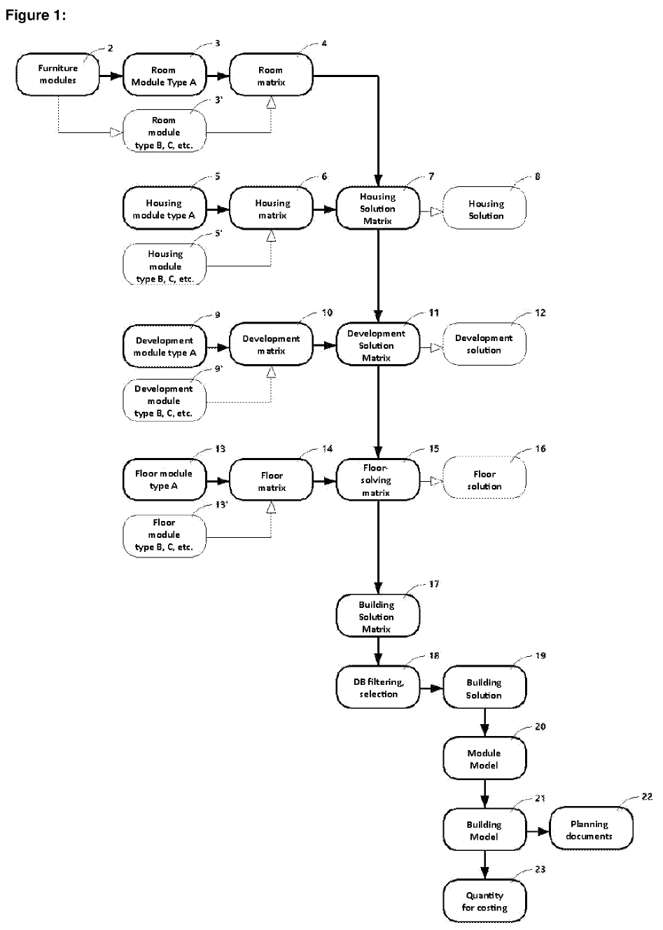

FIG. 1 shows schematically and by way of example the computer- and/or network-based method. Each component of this figure provided with reference numerals has a number as reference numeral which corresponds to the number of that following figure in which this component is represented in detail. Modules are initially provided for the furniture types 2, the room type A 3 (types A, B, C,... are exemplary types of a room), the development type A 9 (types A, B, C,... are exemplary types of developments) and the floor level type A 13 (types A, B, C,... are exemplary types of floor levels), which contain essential technical specifications, parameter ranges for dimensions and/or restrictions for the respective type.

In a next step, the room matrix 4 is created with at least one room type, but preferably with a plurality of room types, taking into account the modules for the room type A 3. The room matrix encompasses all possible forms of these room types and thus associated adapted modules for each apartment layout.

The furniture modules 2 preferably serve as an indicator of the quality of a room-module embodiment, since certain rooms must accommodate a minimum number of certain furniture items in order to ensure the function of the room and thus also the function of the apartment, the access, the floor and finally the building. “Good” is a room-module embodiment, for example, if the movement surfaces of the individual required furniture modules 2 overlap as much as possible within a room-module embodiment 3, but do not overlap with the actual furniture, since restrictions could then occur.

In a next step, the housing matrix 6 is produced with at least one apartment type 5, but preferably with a plurality of apartment types, taking into account the modules for the apartment type 5. The housing matrix includes all possible characteristics of these apartment types and thus associated adapted modules for each floor plan.

Matrices for the development type 9 and the floor level type 13 are also preferably produced.

In the following step, all possible combinations of apartments in the housing matrix 6 and rooms from the room matrix 4 are calculated and stored in the housing solution matrix 7. An apartment solution 8 in this matrix is composed of an embodiment of an apartment type (for example 5), of the housing matrix 7 and of the compatible, jointly or, if appropriate, alone fitting embodiments of the room types (for example 3) from the room matrix 4.

In a next step, all possible combinations of developments in the development matrix 10 and apartments from the housing solution matrix 7 are calculated and stored in the development solution matrix 11. A development solution in this matrix 12 is composed of a Characterisation of a development type (for example 9) from the development matrix 10 and the compatible developments of the housing solutions (for example 8) from the housing solution matrix 7 which fit in together or, if appropriate, alone.

In a next step, all possible combinations of floor levels in the floor level matrix 14 and developments from the development solution matrix 11 calculated and stored in the floor level solution matrix 15. A floor level solution 16 in this matrix is composed of a characteristic of a floor level type (e.g. 13) from the floor level matrix 14 and the compatible characteristics of the development solutions (e.g. 12) from the development solution matrix 11 that fit together or, if applicable, alone.

In the following step, all possible stacked combinations of the floor levels with one another are calculated from the floor level solution matrix 15 (compatible with regard to external dimensions, shaft and stairwell positions) and stored in the building solution matrix 17. A building solution 19 in this matrix is composed of a plurality of floor level solutions (e.g. 16) from the floor level-solution matrix 15 stacked one on top of the other.

In doing so, the floor level matrix 14 (including modules 13) for the floor level type and/or the specified dimensions of the residential building, the development matrix 10 (including modules 9) of the at least one specified development type and/or the apartment matrix 6 (including modules 5) of the at least one specified apartment type can be taken into account and structural variables can be determined and/or adjusted with mutual consideration of the modules. Depending on whether a development matrix 10 and/or a floor matrix 14 have already been created beforehand to match these dimensions, the respective embodiments are included or preferably only calculated at this point.

In the following step, the building solution matrix 17 is represented visually in tabular form with essential aggregated parameters of calculated building solutions (including the dwellings, developments and/or floors contained therein 18). In this illustration 18, it is possible to filter the solutions contained in the building solution matrix 17 (e.g. 19) according to specific values (e.g. number of floors, length and width of the building, number of individual types of apartments, accessibility of the apartments) and to sort these filtered solutions on the basis of the parameters / properties / features of the building solutions (e.g. according to area, quality and quantity values) and to make a selection. This selected building solution 19 (if necessary also several solutions) can now be transferred to a CAD program (preferably Autodesk Revit) and interpreted with the aid of a script as room, apartment, development and floor modules 20, which are placed, optionally rotated, mirrored and parametrically adjusted. This abstracted representation, consisting only of “lines”, allows the planner to view the solution, check for errors and evaluate it subjectively before generating the final digital 3D building model 20.

If the planner finds the solution to be good, the next step is to generate the 3D building model 21 in the CAD program with the aid of a script based on the modules 20, consisting of individual digital components (walls, ceilings, furniture, doors, windows, stairs, balconies).

This is followed by the creation of a 3D model of calculated apartments, developments and/or residential buildings.

Based on the 3D building model, the plan views and necessary lists (area lists, quantities) / data are now derived 22. Since the automated module-based generation of the 3D building model achieves a higher accuracy and a higher degree of detail than with “manual” modelling, the 3D building model already provides a large part of the volumes / quantities 23 required for the calculation.

In the following figures, the lines with the stronger line thickness emphasize the types, which will be discussed in more detail in the following figures. Illustrations with lower line thicknesses show further possible solutions/characteristics.

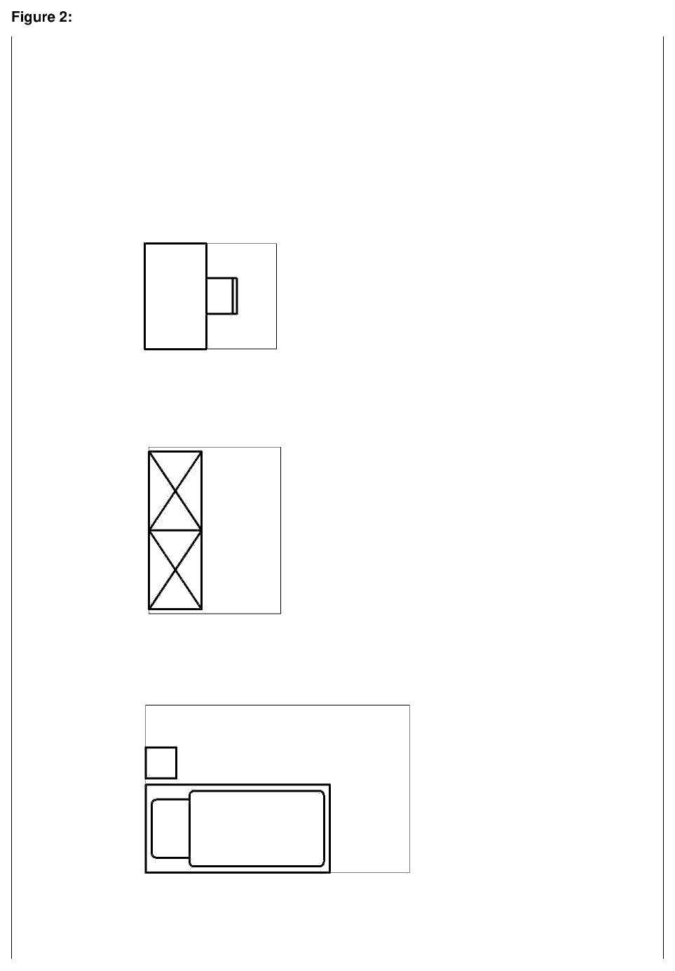

In FIG. 2, the thinner lines show movement surfaces of the individual furniture. FIG. 2 shows a selection (single bed, wardrobe and desk) of furniture modules (in 2D) in a CAD program. This furniture in this number is also the required furniture that must at least be present in the furniture module type A. The dashed areas mark the movement areas of the modules which are necessary for the function to be ensured.

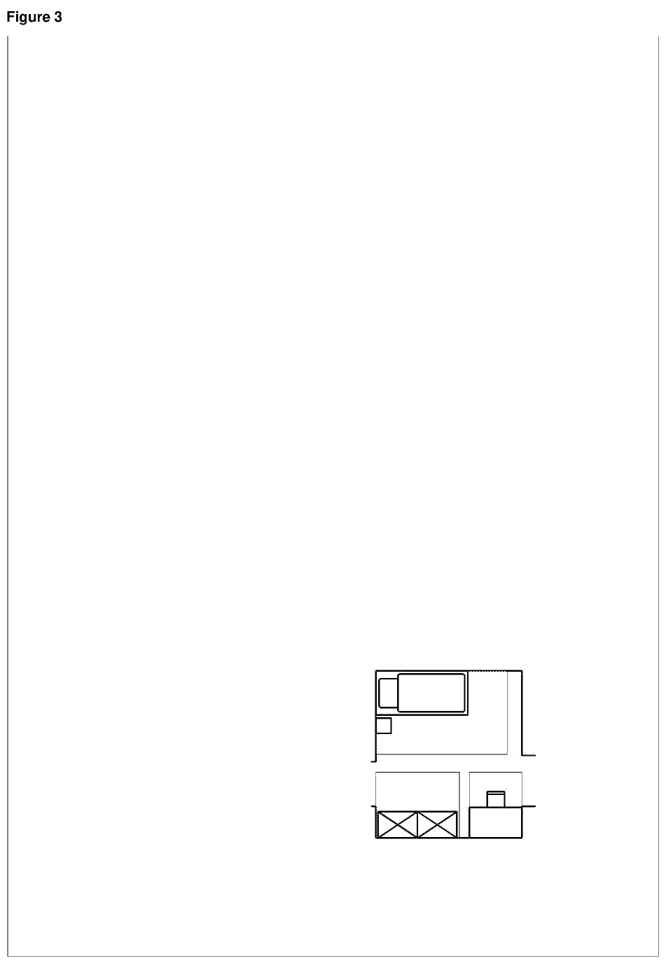

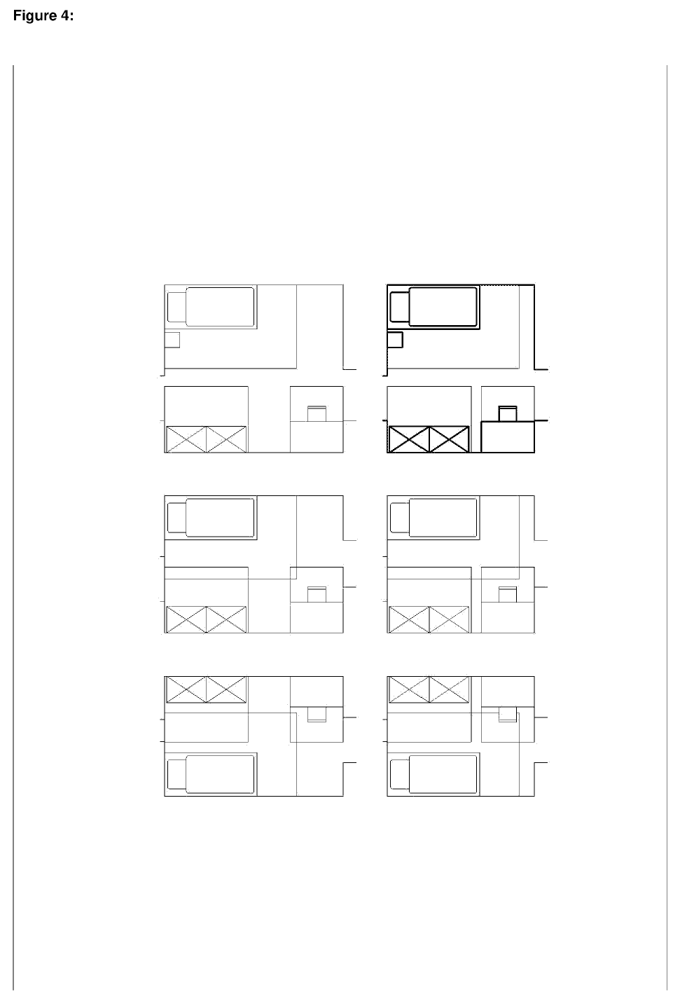

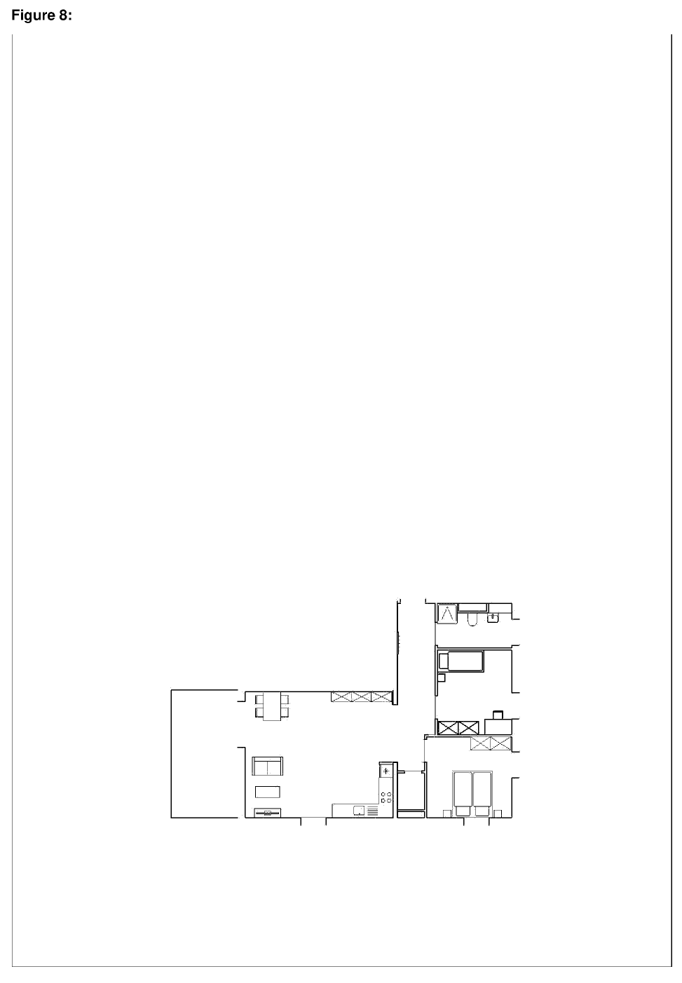

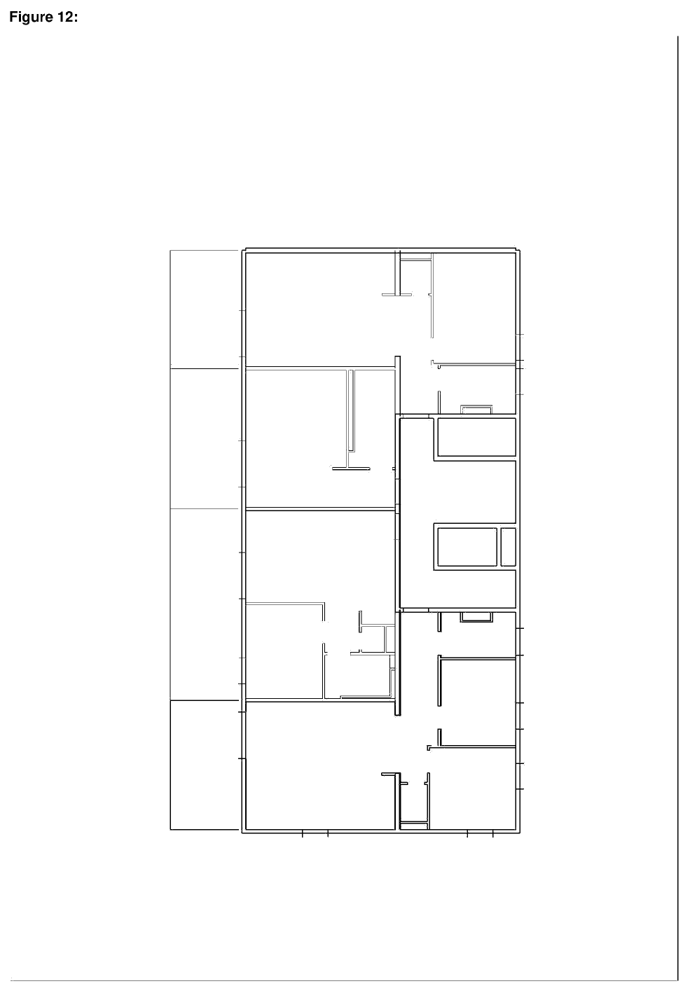

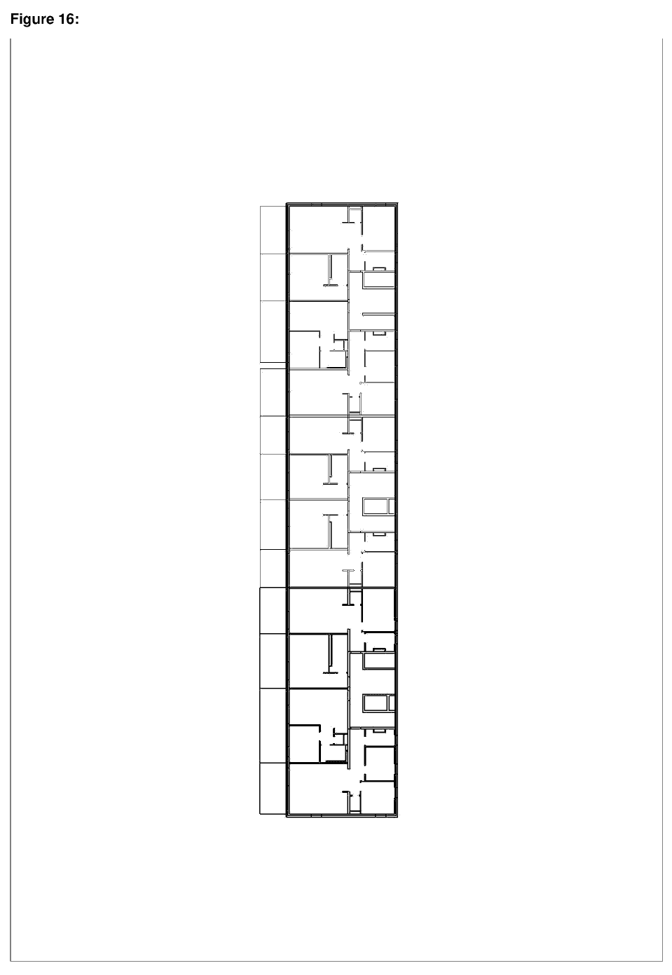

FIG. 3 shows a version of the furniture module type A (here e.g. room) (in 2D) in a CAD program. This includes the furniture modules shown in FIG. 2. The furniture modules represent the smallest building subunit in the entire process. They also form the basic unit, since they determine whether a room is functional. If the room module (FIG. 4) cannot hold the necessary furniture, it is not functional. Thus, the apartment solution (FIG. 8), development solution (FIG. 12), floor solution (FIG. 16) and ultimately also the entire building solution (FIG. 12), in which it is also not hidden. It can be manipulated in its outer dimensions and the inner life adapts to this. It serves in the process of visualization, the determination of the qualities and as a place holder for elements that form the 3D building model in the later course.

FIG. 4 shows an abstracted partial section of the room matrix, in which several forms of the room module type A (here, for example, room) can be seen. It is first generated automatically in the CAD program with the aid of a script. Each room module of the same type in this matrix has different dimensions. In the next step, the modules are analysed and filled with attributes, such as area values and qualities. The quality of the room is determined by several factors. The quality of the room increases, for example, if, among other things, the movement surfaces overlap more strongly without touching the actual furniture, so that the function is still given. These elements are then abstracted in a tabular form (CSV, TXT, etc.) and fed into the database. This method has proven itself for all types of modules, since modules can be easily created for planners in the CAD program (Revit) and a certain amount of intelligence can be built into them (e.g. the bedside table disappears if the door is too close to the bed). This comes close to normal planning and thus ensures that the non-specialist computer scientists do not have to take over the planning.

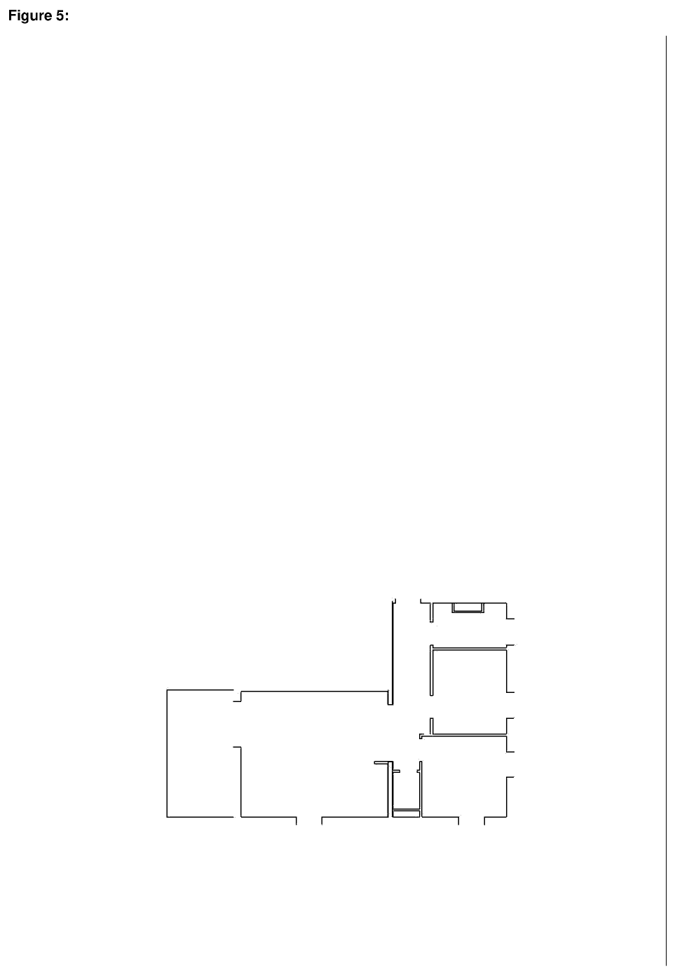

FIG. 5 shows an embodiment of the Type A residential module (here, for example, 3-room, L-shape) (in 2D) in a CAD program. It can be manipulated in its outer dimensions and the inner life adapts to this. It serves in the process of visualization, the determination of the qualities and as a place holder for elements that form the 3D building model in the later course.

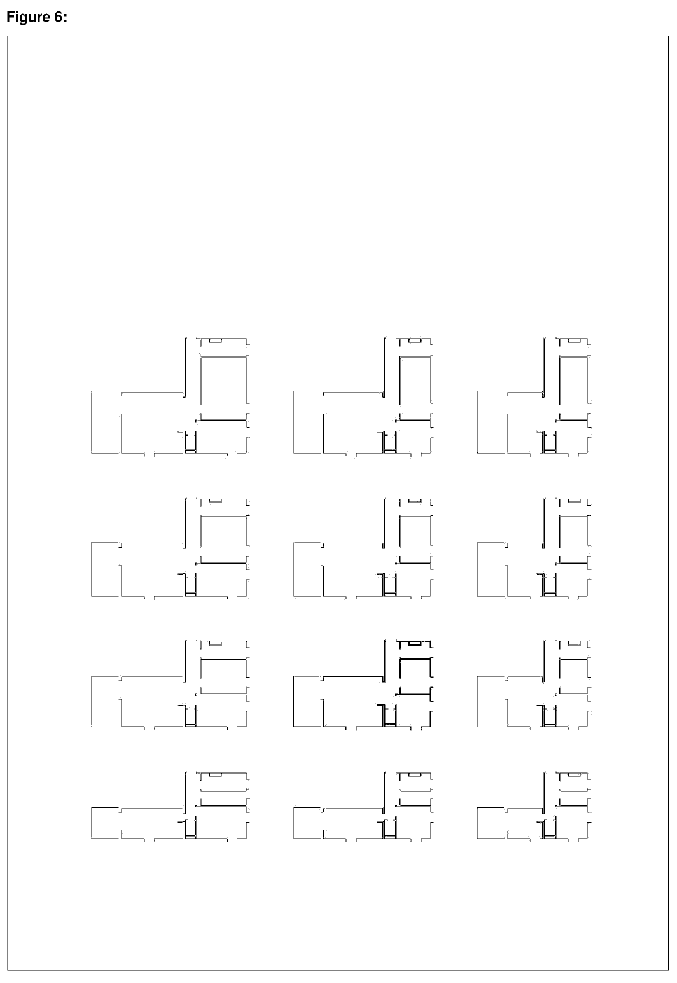

FIG. 6 shows an abstract partial section of the housing matrix, in which several characteristics of the apartment module type A (here e.g. 3-room, L-shape) can be seen. It is first generated automatically in the CAD program with the help of a script. Each apartment module of the same type in this matrix has different dimensions. In the next step, the modules are analysed and filled with attributes, such as area values and qualities. These elements are then abstracted in a tabular form (CSV, TXT, etc.) and fed into the database. This method has proven itself for all types of modules, since modules can easily be created for planners in the CAD program (Revit) and a certain amount of intelligence can already be built into them (e.g. that the fire walls maintain their distance with changing dimensions and the others orient themselves to it). This comes close to conventional planning and thus ensures that the computer scientists who are not specialists here do not have to take over the planning.

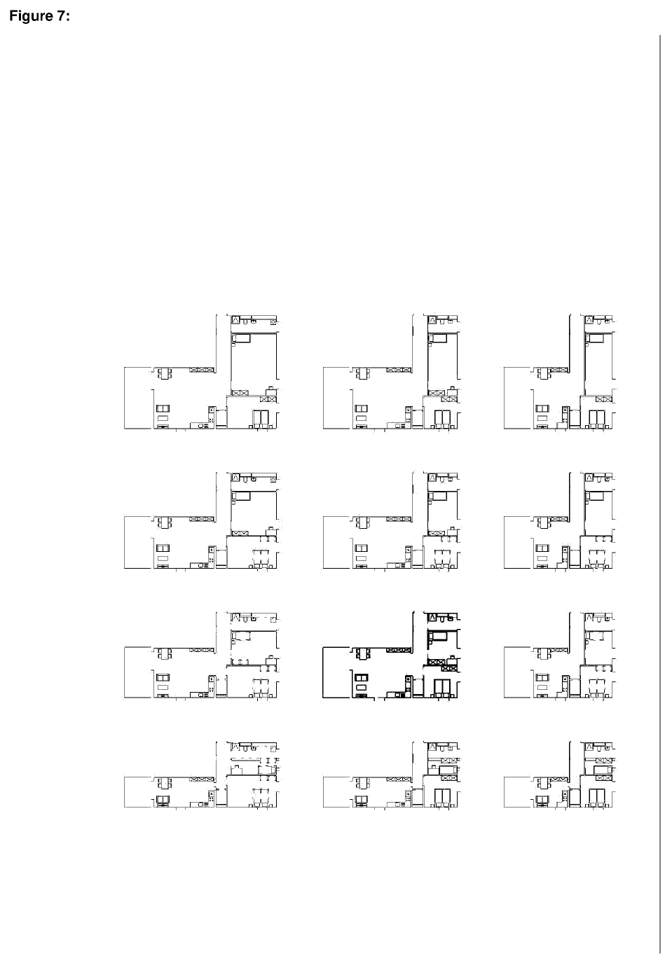

FIG. 7 shows in abstract form a partial section of the housing solution matrix in which several characteristics of the housing solutions module based on type A can be seen. This process takes place within the database and was only made visible here with the help of the modules in the CAD program. The method attempts to fill every apartment in the housing matrix with the rooms from the room matrix, provided that the restrictions of the modules allow it. For example, there can be several versions with different room combinations for one type of apartment, which have different features from one another.

FIG. 8 represents an abstracted solution from the housing solution matrix. The quality of the apartment is the buzzer of the qualities of the room characteristics that are housed in it.

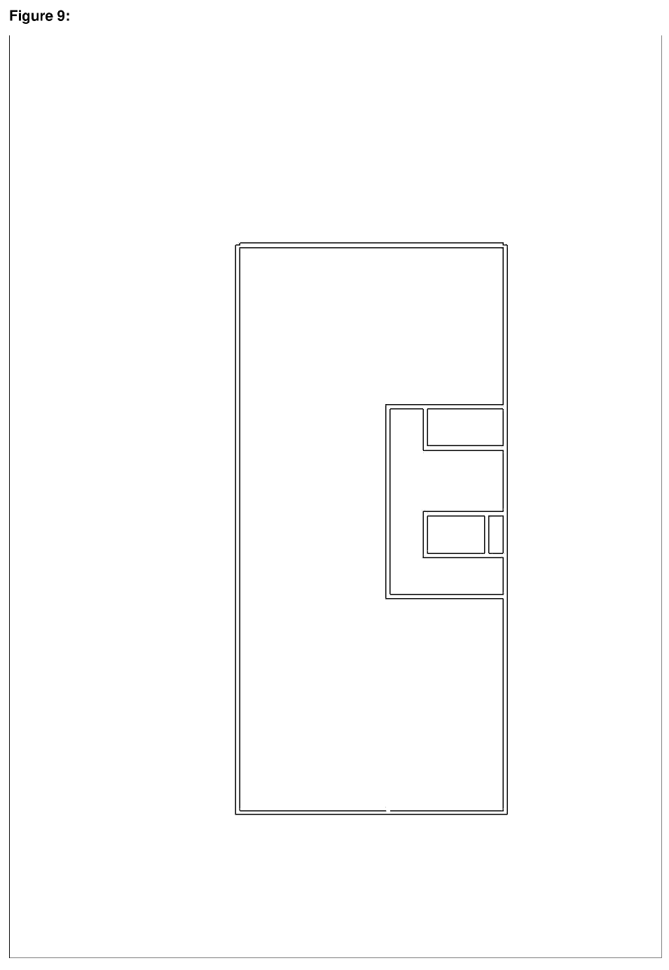

FIG. 9 shows a plan view of a development module type A (here, for example, 4-channels, ground floor, with elevator and technical room) (in 2D) in a CAD program. It can be manipulated in its outer dimensions and the inner life adapts to this. It serves in the process of visualization, the determination of the qualities and as a place holder for elements that form the 3D building model in the later course.

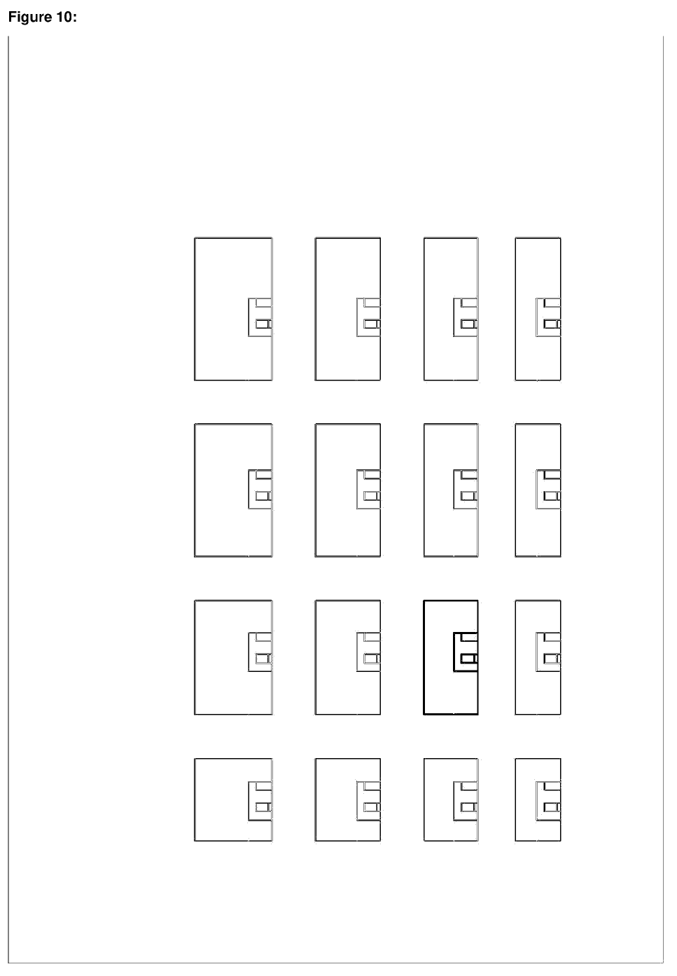

FIG. 10 shows an abstract partial section of the cataloguing matrix in which several characteristics of the cataloguing module type A can be seen. It is first generated automatically in the CAD program with the help of a script. Each apartment module of the same type in this matrix has different dimensions. In the next step, the modules are analysed and filled with attributes, such as area values and qualities. These elements are then abstracted in a tabular form (CSV, TXT, etc.) and fed into the database. This method has proven itself in all types of modules, since modules can be easily created for planners in the CAD program (Revit) and a certain amount of intelligence can already be built into them (e.g. that the walls of the staircase core maintain the distances between each other and the staircase core only shifts as a whole in the development). This comes close to conventional planning and thus ensures that the non-specialist computer scientists do not have to take over the planning.

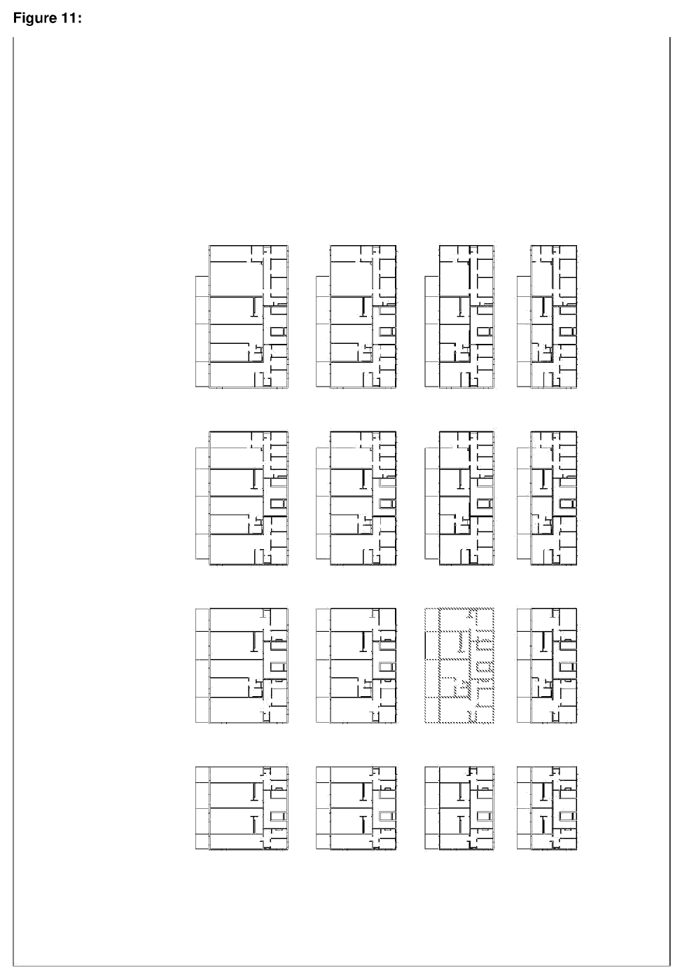

FIG. 11 shows an abstract partial section of the development solution matrix, in which several characteristics of the development solution module based on type A can be seen. This process preferably takes place within the database and was only made visible here with the aid of the modules in the CAD program. The method attempts to fill every development in the development matrix with every apartment solution from the apartment solution matrix, provided that the restrictions of the modules allow it. For example, there may be several versions with different apartment combinations for a particular development, which have different features from one another.

FIG. 12 shows an abstract solution from the development solution matrix. The quality of the development is the buzzer of the qualities of the housing solutions housed in it.

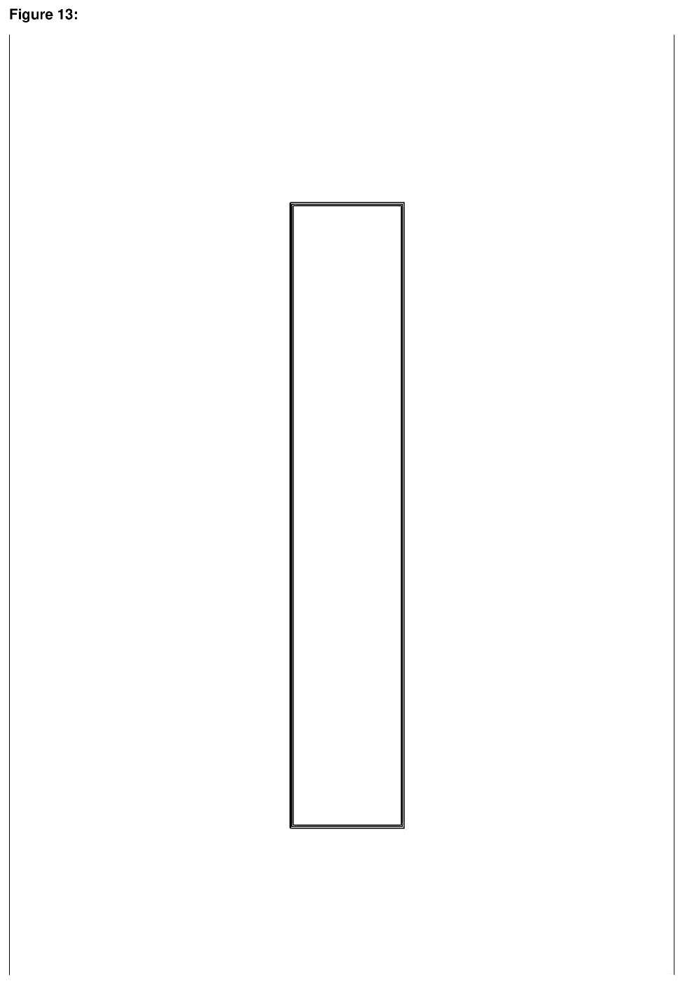

FIG. 13 shows a design of the type A floor level module (here, for example, rectangle, ground floor) (in 2D) in a CAD program in a plan view. It can be manipulated in its outer dimensions and the inner life adapts to this. It serves in the process of visualization, the determination of the qualities and as a place holder for elements that form the 3D building model in the later course.

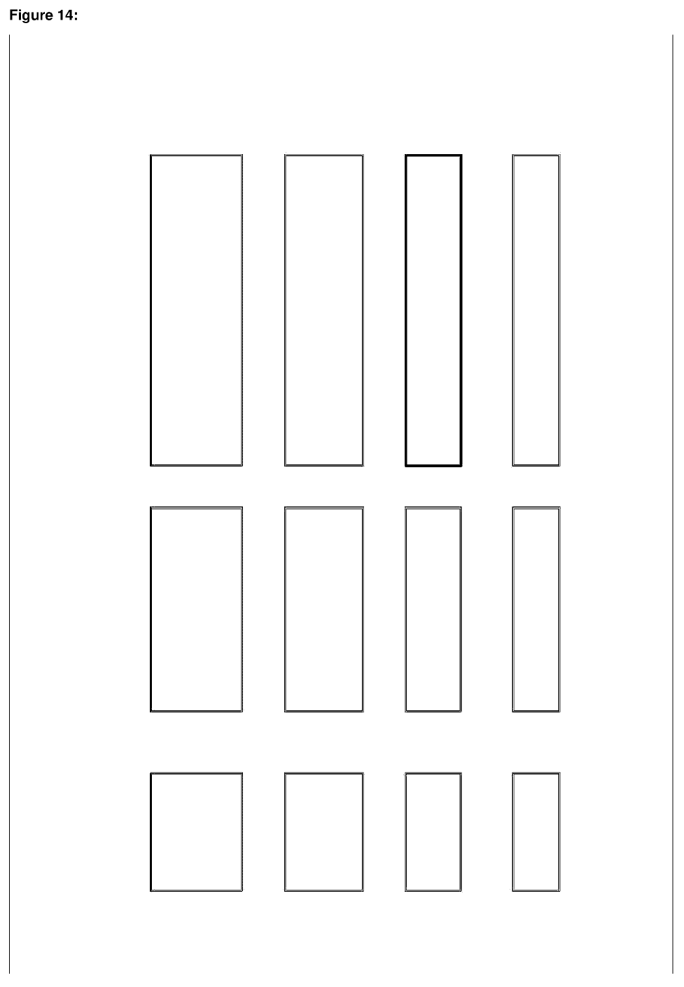

FIG. 14 shows an abstracted partial section of the floor level matrix, in which several features of the floor level module type A can be seen. It is first generated automatically in the CAD program with the aid of a script. Each floor level module of the same type in this matrix has different dimensions. In the next step, the modules are analysed and filled with attributes, such as area values and qualities. These elements are then abstracted in a tabular form (CSV, TXT, etc.) and fed into the database. This method has proven itself for all types of modules, since modules can easily be created for planners in the CAD program (Revit) and a certain amount of intelligence can be built into them (e.g. the distance between the outer walls with different material thicknesses). This comes close to conventional planning and thus ensures that the non-specialist computer scientists do not have to take over the planning.

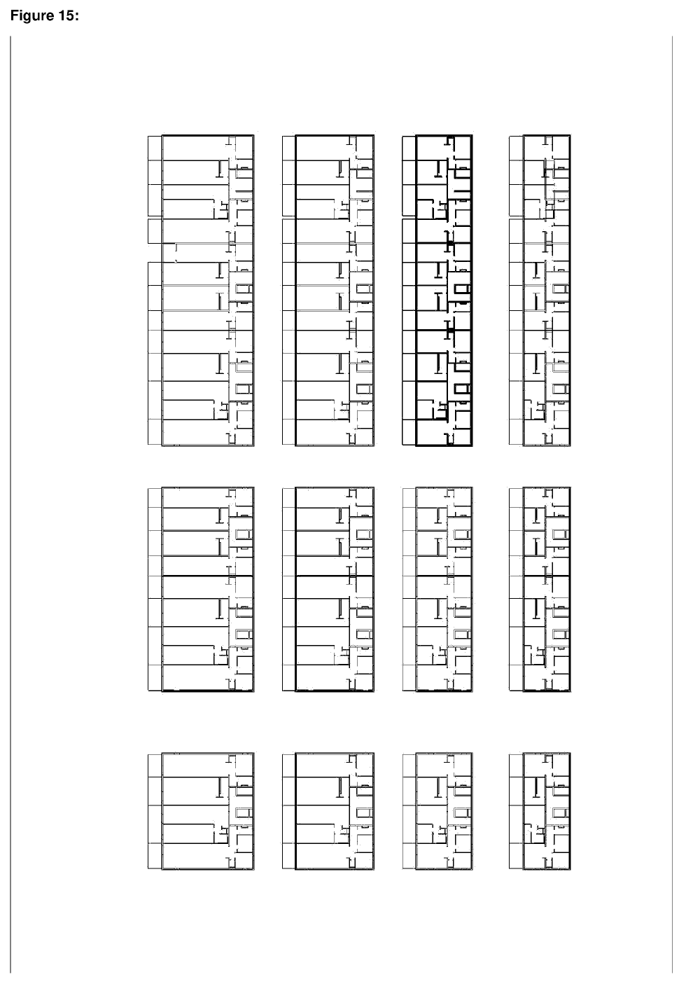

FIG. 15 shows an abstracted partial section of the floor level solution matrix, in which several characteristics of the floor level solution module based on type A can be seen. This process takes place within the database and was only made visible here with the help of the modules in the CAD program. The method attempts to fill each floor level in the floor level matrix with each development solution from the development solution matrix, provided that the restrictions of the modules permit it. For example, there can be several versions with different development combinations for a floor level design, which have features differing from one another.

FIG. 16 illustrates an abstracted solution from the floor level solution matrix. The quality of the floor level is the sum of the qualities of the development solutions housed in it.

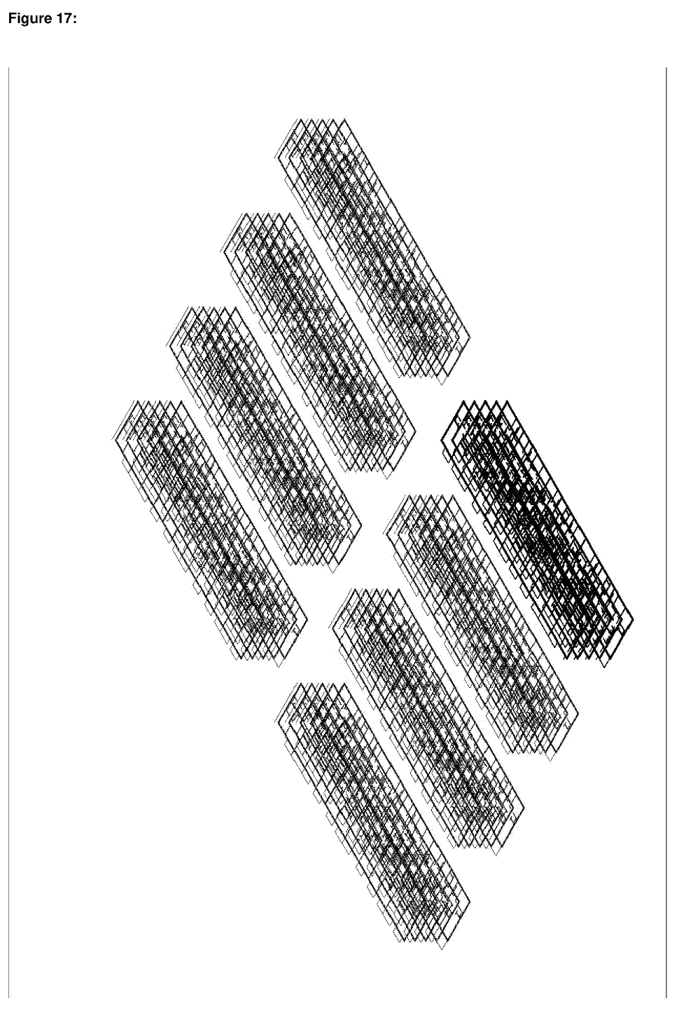

FIG. 17 shows an abstract partial section of the building solution matrix, in which several characteristics of the building solutions module can be seen. This process takes place within the database and was only made visible here with the help of the modules in the CAD program. The method attempts to vertically combine (stack) the floor levels in the floor level solution matrix, provided that the restrictions of the modules allow it. For example, there may be several versions with different floor combinations for a building design (external dimensions and floors), which have different features from one another.

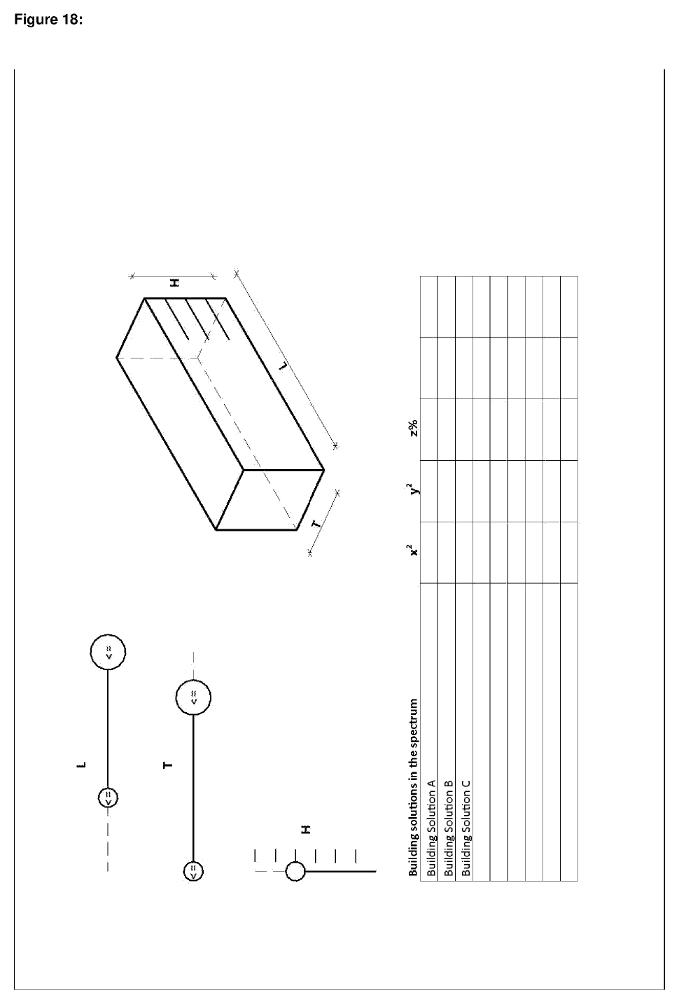

FIG. 18 shows an abstract representation of the user interface with the aid of which a selection for the further steps can be made from the set of building solutions from the building solution matrix. The functions shown: selectable floors, additional display of the building length and width, other indicators for areas, lengths, percentage displays.

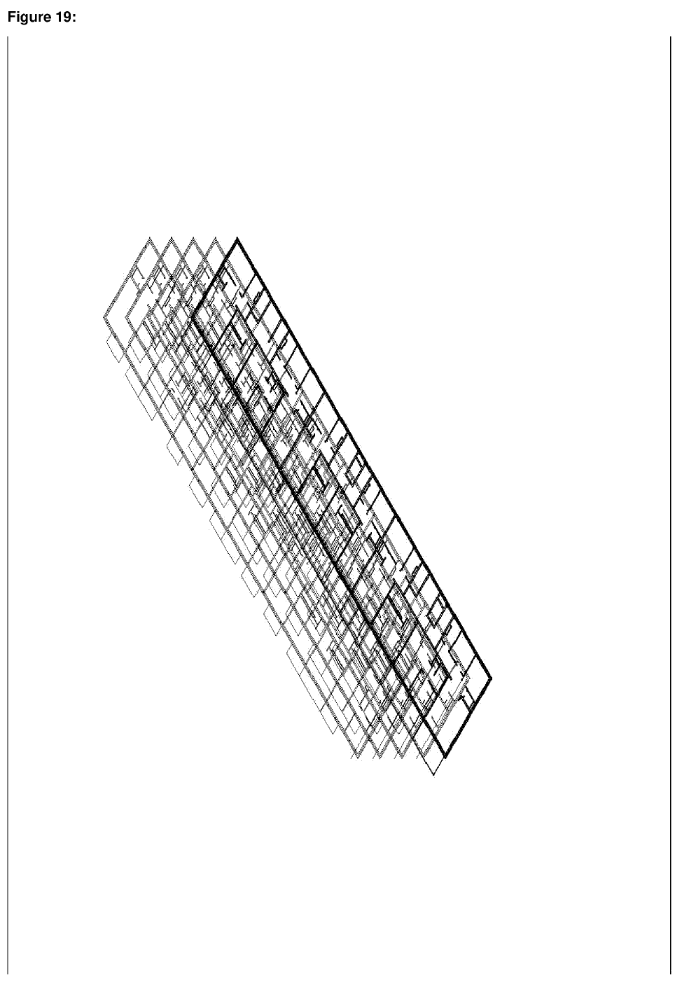

FIG. 19 represents an abstracted solution from the building solution matrix. The quality of the building is the buzzer of the qualities of the floor solutions housed in it. This solution is handed over to the CAD program.

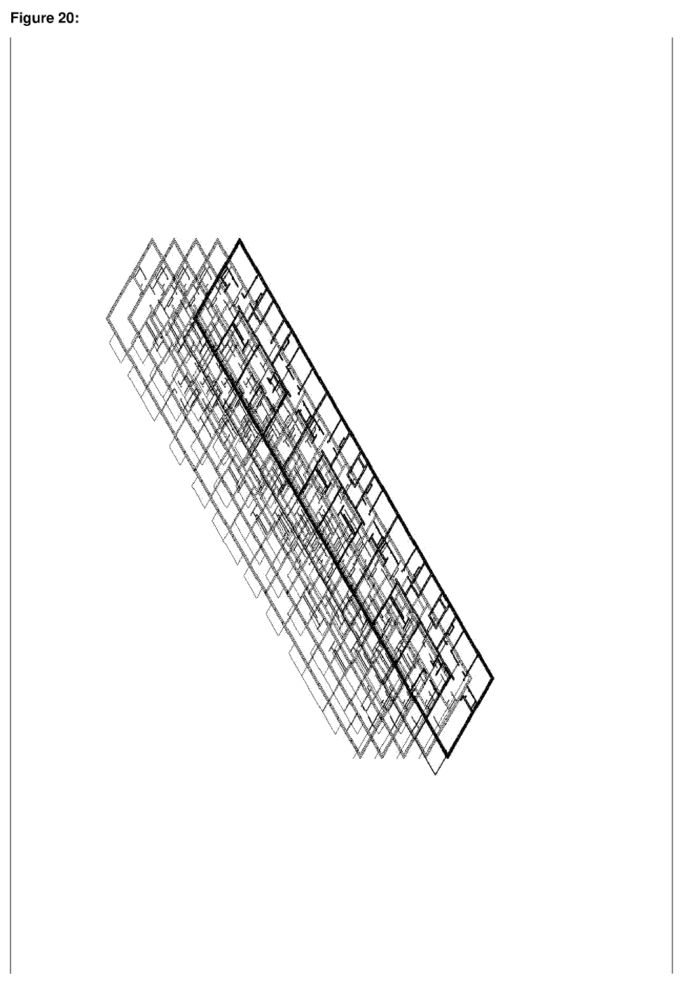

FIG. 20 shows the result of the solution import. With the help of an automation script, the characteristics of the module types (including room module type A FIG. 3, apartment module type A FIG. 5, development module type A FIG. 9 and floor module type A FIG. 13) are placed within the CAD program, if necessary rotated and attributed.

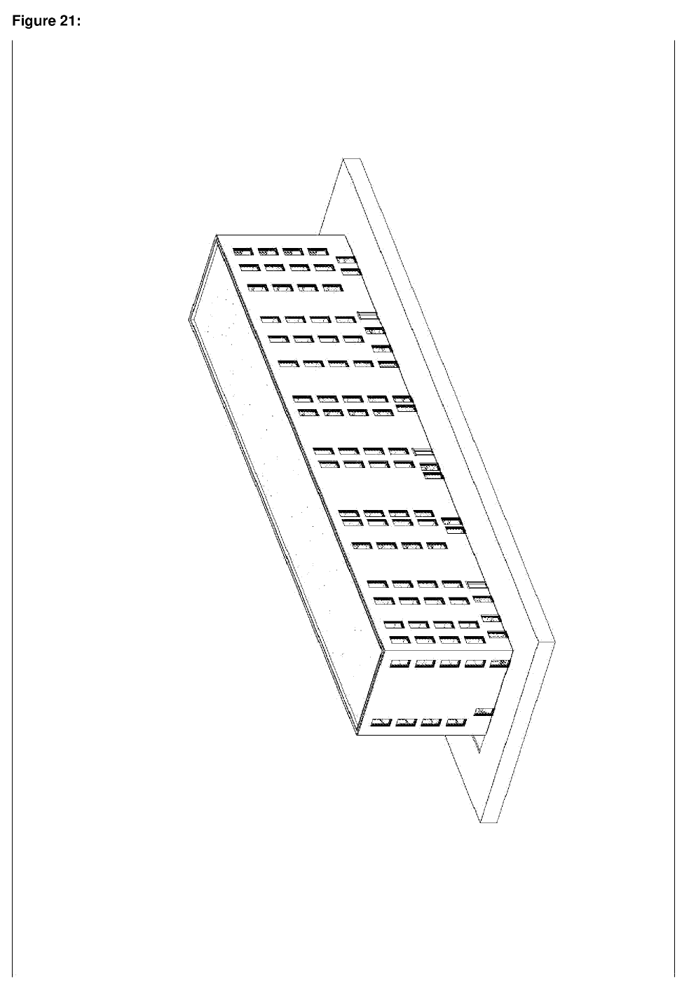

FIG. 21 illustrates the 3D building model that was created on the base of the modules from individual components (walls, floor ceilings, doors, windows, stairs, elevators, furniture).

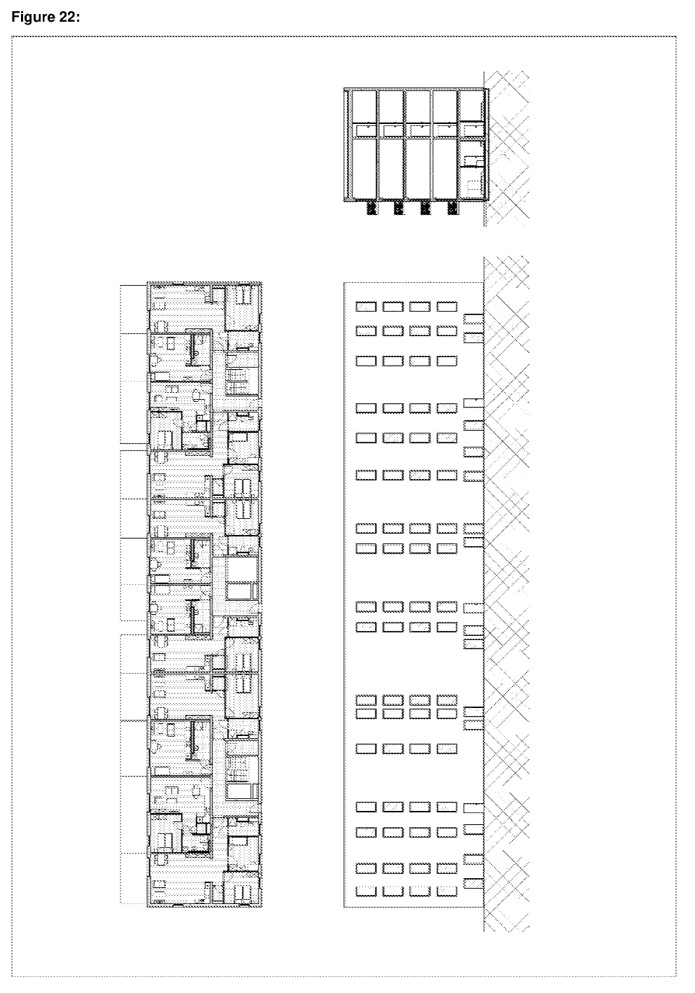

FIG. 22 abstracts the plan views derived from the 3D building model.

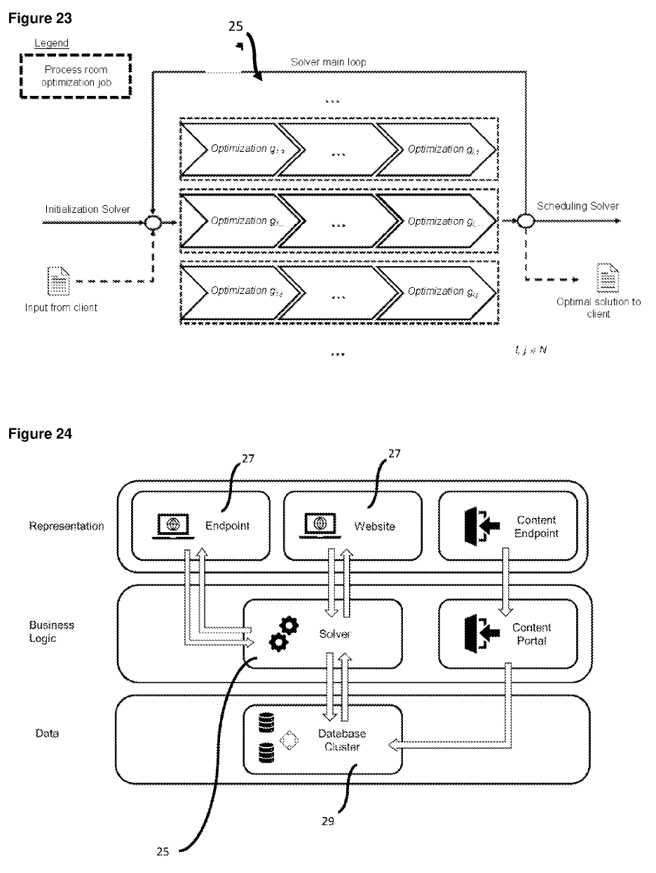

FIG. 23 illustrates a flowchart of calculations on a server device 25. The server device 25 is preferably in data connection with a client 27 (not shown in the figure) and receives an input data record from the client. The server device 25 then carries out a multiplicity of optimizations, it being possible for individual calculation steps and/or individual optimizations as such to be carried out on various different servers which are in data connection with one another. Optimization is preferably carried out via an algorithm of the harmonic search, optimization preferably representing an optimum solution for a building specification. The information values included in the input data set (namely: material-related and/or geometry-related building parameters and/or environmental-related parameters and/or parameters relating to the building subunit mix as well as the minimum square meter size and/or maximum square meter size of the at least one building subunit) are initially initialized. Subsequently, a harmonic memory is generated and new solutions are generated in the course of the optimizations. As already discussed, a plurality of optimizations are preferably carried out in parallel on the server device 25, optimization preferably taking place with respect to a building subunit mix, to a building geometry and/or to a building environment. New solutions generated by the algorithm are evaluated and annotated, new solutions being continuously generated in an iteration loop until a holding criterion is reached. The annotated solutions are then transmitted to a database server which is connected to the server device and in which the solutions are stored. Furthermore, an output data set comprising the optimal obtained solution for a building specification is generated and transmitted to the client 27. The output data set is interpretable as CAD data and can subsequently be read out in a CAD tool included on the client 27, whereby a building plan is obtained.

FIG. 24 is a representation of a preferred client server model. For the purposes of the invention, a client 27 is preferably configured as an entity, the entity being an Internet-enabled terminal and/or a computer program product installed on a terminal and/or a web application. In the present case, two clients 27 are in data connection with a preferred server device 25. On the other hand, the server device 25 is in data connection with a database server 29. The respective clients 27 are preferably set up to load material-related and/or geometry-related building parameters and/or environmental-related parameters and/or parameters relating to the building subunit mix as well as the minimum square meter size and/or maximum square meter size of the at least one building subunit into a memory and to generate an input data record. Subsequently, the input data record can be transmitted to the server device 25. On the other hand, the server device 25 is preferably set up to execute an algorithm of the harmonic search and to generate an output data record, with the input data record being included, the output data record comprising a building specification optimized for the development area and country-specific building specifications. Furthermore, the server client 25 is set up to transmit an output data record, preferably to a client 27. In this case, the server device 25 preferably comprises a plurality of servers, the servers being in data connection with one another and being able to carry out calculations cooperatively. Furthermore, the server device 25 preferably stores annotated solutions on the database server 29. The communication between server device 25 and database server 29 is preferably bidirectional. Thus, on the one hand, the server devices can store the solutions on the database server 29 and, on the other hand, can access already stored solutions which are provided by the database server 29.

Furthermore, the database server is in data connection with a content portal. The content portal (CP) is a further server device which manages self-created content of privileged users. In this connection, for example, a floor plan can be drawn in a CAD program which is also to be used in the future for the server device 25 during the optimization. Thus, the floor plan, with corresponding annotations, is loaded into the system via the associated “content endpoint”. The CP will clean up the imported data record and, for example, import the annotations into the database and organize the delivery or updating of the floor plan to other users.

REFERENCE LIST

| | |
|---|---|
| 2 | furniture modules |
| 3 | room module |
| 4 | room module |
| 5 | Apartment module |
| 6 | Housing matrix |
| 7 | Housing Solution Matrix |
| 8 | Housing Solution |
| 9 | Development module |
| 10 | Development matrix |
| 11 | Development Solution Matrix |
| 12 | Development solution |
| 13 | Floor level module |
| 14 | Floor level matrix |
| 15 | Floor level solution matrix |
| 16 | Floor level Solution |
| 17 | Building Solution Matrix |
| 18 | Filters |
| 19 | Building Solution |
| 20 | Module Model |
| 21 | Building Model |
| 22 | Planning documents |
| 23 | Quantity output for calculation |
| 25 | Server Setup |
| 27 | Client |
| 29 | Database servers |

FIG. 1 LEGEND

| | |
|---|---|
| 2 | Furniture modules |
| 3 | Room module type A |
| 3′ | Room module type B, C, etc. |
| 4 | Room matrix |
| 5 | Apartment module type A |
| 5′ | Apartment module type B, C, etc. |
| 6 | Housing matrix |
| 7 | Housing Solution Matrix |
| 8 | Housing Solution |
| 9 | Development module type A |
| 9′ | Development module type B, C, etc. |
| 10 | Development matrix |
| 11 | Development Solution Matrix |
| 12 | Development solution |
| 13 | Floor level module type A |
| 13′ | Floor level module type B, C, etc. |
| 14 | Floor level module matrix |
| 15 | Floor level solution matrix |
| 16 | Floor level Solution |
| 17 | Building Solution Matrix |
| 18 | DB filtering, selection |
| 19 | Building Solution |
| 20 | Module Model |
| 21 | Building Model |
| 22 | Planning documents |
| 23 | quantities for calculation |

1-15. (canceled)

16. A method for producing a building with at least one building subunit, comprising:
obtaining parameters in response to at least one of detection or analysis of a building surface, wherein the parameters are material-related parameters and geometry-related building parameters and parameters relating to a building subunit mix, wherein the material-related parameters and geometry-related building parameters are continuously detected and analysed;
generating a building area of the at least one building subunit, the building area having a minimum area and maximum area, which is based on collection, analysis and/or preparation of text data with country-specific construction specifications;
loading the parameters and the building area of the at least one building subunit into a memory of a client device;
generating, with the client device, an input data set that includes an information content on the material-related parameters and geometry-related building parameters and parameters relating to the building subunit mix and the building area of the at least one building subunit;
transmitting the input data set from the client device to a server device;
executing, with the server device, a harmonic search algorithm of the input data set;
generating, with the server device, an output data set that has a building specification adapted to the building area and the country-specific construction specifications, wherein the output data set comprises data that can be interpreted for a CAD system;
transmitting the output data set from the server device to the client device;
generating, with the client device, a building plan with at least one building subunit based on the building specification of the output data set and the building area and the country-specific construction specifications, wherein the building plan is based on a CAD model, wherein the CAD model is a 3D building model; and
initiating construction of the building with the building subunit based on the building plan.

17. The method of claim 16, wherein the harmonic search algorithm represents an optimization and comprises the following steps:
a. initializing the material-related parameters and/or geometry-related building parameters and parameters relating to the building subunit mix as well as the minimum area and/or maximum area of the at least one building subunit;
b. setting up a harmonic memory;
c. improvising new solutions;
d. evaluating and annotating the new solutions and updating the harmonic memory; and
e. repeating steps c. and d. until a holding criterion is reached.

18. The method of claim 17, further comprising:
performing a plurality of optimizations that are carried out in parallel on the server device, the plurality of optimizations being carried out in relation to the building subunit mix and to a building geometry.

19. The method of claim 18, wherein the server device is in data connection with a database server, wherein an annotated solution is stored on the database server.

20. The method of claim 18, wherein the server device comprises a plurality of servers, the servers being in data communication with each other and cooperatively performing calculations.

21. The method of claim 16, wherein the client device is configured as an entity, wherein the entity includes an internet-enabled terminal and a computer program product and/or a web application installed on the internet-enabled terminal.

22. A system for producing a building comprising at least one building subunit, wherein the system comprises a client device, a server device, a detection device, and a workstation, the client device is communicatively coupled with the server device, the detection device, and the workstation, wherein:
the client device is configured to:
load material-related parameters and geometry-related building parameters and parameters relating to the building subunit mix as well as a development area having a minimum area and maximum area of the at least one building subunit into a memory of the client device;
generate an input data set that includes an information content about material-related parameters and geometry-related building parameters and parameters relating to the building subunit mix as well as the minimum area and/or maximum area of the at least one building subunit;
transmit the input data set to the server device ; and
generate a building plan based on an output dataset;
the server device is configured to:
execute a harmonic search algorithm with the input data set to generate an output data set, the output data set comprising a building plan adapted to the development area and country-specific building specifications; and
transfer the output data record to the client, wherein the output data set comprises data that can be interpreted for a CAD system and the building plan is based on a CAD model, wherein the CAD model is a 3D building model;
the workstation is configured to carry out construction of the building with the at least one building sub-unit, taking into account the building plan;
the detection device is configured to:
record and analyse a building area, whereby the material-related parameters and geometry-related building parameters and the building subunit mix are obtained, wherein the material-related parameters and geometry-related building parameters are continuously detected and analysed; and
capture, analyse, and/or process text data with the country-specific building specifications, thereby generating the minimum area and maximum area of the at least one building subunit.

23. The system of claim 22, wherein the server device is configured to execute the harmonic search algorithm, which represents an optimization and comprises the following steps:
a) initialization of material-related parameters and geometry-related building parameters and parameters relating to the building subunit mix as well as the minimum area and/or maximum area of the at least one building subunit;
b) construct a harmonic memory;
c) improvise new solutions;
d) evaluate and annotate the new solutions and update the harmonic memory; and
e) repeat steps c) and d) until a holding criterion is reached.

24. The system of claim 23, wherein the server device is in data connection with a database server and is configured to:
carry out a plurality of optimizations in parallel, each optimization being carried out in relation to a building subunit mix and a building geometry; and
storing an annotated solution on the database server;
wherein the server device comprises a plurality of servers which are data-connected to one another and perform calculations cooperatively.

25. The system of claim 22, wherein the client device is configured as an entity, wherein the entity includes an internet-enabled terminal and a computer program product and/or a web application installed on the internet-enabled terminal.

26. A computer program product comprising computer-executable instructions that when executed perform a method for generating a building plan, wherein the computer-executable instructions are stored on at least one non-transient medium that can be used in a computer, the method comprising:
obtaining parameters in response to at least one of detection or analysis of a building surface, wherein the parameters are material-related parameters and geometry-related building parameters and parameters relating to a building subunit mix, wherein the material-related parameters and geometry-related building parameters are continuously detected and analysed;
generating a building area of the at least one building subunit, the building area having a minimum area and maximum area, which is based on collection, analysis and/or preparation of text data with country-specific construction specifications;
loading the parameters and the building area of the at least one building subunit into a memory of a client device;
generating, with the client device, an input data set that includes an information content on the material-related parameters and geometry-related building parameters and parameters relating to the building subunit mix and the building area of the at least one building subunit;
transmitting the input data set from the client device to a server device;
executing, with the server device, a harmonic search algorithm of the input data set;
generating, with the server device, an output data set that has a building specification adapted to the building area and the country-specific construction specifications, wherein the output data set comprises data that can be interpreted for a CAD system;
transmitting the output data set from the server device to the client device; and
generating, with the client device, a building plan with at least one building subunit based on the building specification of the output data set and the building area and the country-specific construction specifications, wherein the building plan is based on a CAD model, wherein the CAD model is a 3D building model; wherein
the input data set includes an information content about material-related parameters and geometry-related building parameters and a building subunit mix as well as the minimum area and/or maximum area of the at least one building subunit; and
the output data set includes a building specification adapted to the building area and country-specific building specifications.

27. The computer program product of claim 26, wherein the server device is configured to execute the harmonic search algorithm, which represents an optimization and comprises the following steps:
a) initialization of material-related parameters and geometry-related building parameters and parameters relating to the building subunit mix as well as the minimum area and/or maximum area of the at least one building subunit;
b) construct a harmonic memory;
c) improvise new solutions;
d) evaluate and annotate the new solutions and update the harmonic memory; and
e) repeat steps c) and d) until a holding criterion is reached.

28. The computer program product of claim 26, wherein the computer program product is configured to transmit annotated solutions to a database server using technical means of a computer and the computer program product is installed on at least one computer.

29. The method of claim 16, wherein the harmonic search algorithm processes variables of a solution in multiple iterations including at least one of:
leave the variable unchanged;
slightly change the variable; or
completely replace the variable,
which generates a new solution, wherein each new solution is evaluated by heuristics to obtain information with aid of presumptive conclusions.

30. The system of claim 22, wherein the harmonic search algorithm processes variables of a solution in multiple iterations including at least one of:
leave the variable unchanged;
slightly change the variable; or
completely replace the variable,
which generates a new solution, wherein each new solution is evaluated by heuristics to obtain information with aid of presumptive conclusions.

31. The computer program product of claim 26, wherein the harmonic search algorithm processes variables of a solution in multiple iterations including at least one of:
leave the variable unchanged;
slightly change the variable; or
completely replace the variable,
which generates a new solution, wherein each new solution is evaluated by heuristics to obtain information with aid of presumptive conclusions.

32. The method of claim 29, comprising:
analysing each new solution for a criteria;
deleting solutions omitting the criteria; and
storing solutions including the criteria in a database of the server device.

33. The system of claim 30, wherein the server device is configured to:
analyse each new solution for a criteria;
delete solutions omitting the criteria; and
store solutions including the criteria in a database of the server device.

34. The computer program product of claim 31, wherein the server device is configured to:
analyse each new solution for a criteria;
delete solutions omitting the criteria; and
store solutions including the criteria in a database of the server device.
